(19) United States
(12) Patent Application Publication
(10) Pub. No.: US 2008/0230945 A1
(43) Pub. Date: Sep. 25, 2008

(54) SOLUTION CASTING APPARATUS AND SOLUTION CASTING METHOD

(75) Inventors: Daisaku ABIRU, Kanagawa (JP); Ryou TAKEDA, Kanagawa (JP)

Correspondence Address: Young & Thompson, Suite 500, 209 Madison Street, Alexandria, VA, 22314, US

(73) Assignee: FUJIFILM CORPORATION, Tokyo (JP)

(21) Appl. No.: 12/050,970

(22) Filed: Mar. 19, 2008

(30) Foreign Application Priority Data
Mar. 20, 2007 (JP) 2007-071916

(51) Int. Cl. B29C 39/14; B29D 7/01

(52) U.S. Cl. 264/212; 425/224

(57) ABSTRACT

A casting die includes lip plates and inner deckle plates, each of which has a contact face. The contact faces form an outlet of the casing die. A distance between a ridge of the lip plate and that of the inner deckle plate is at most 9 μm. Further, nozzles are disposed so as to be close to the outlet. A periphery of a support runs at more than 50 m/min. A casting dope is discharged from the outlet to the support, so as to form a dope bead between the outlet and the periphery. A decompression chamber decompresses in a rear face side from the dope bead.

### BACKGROUND OF THE INVENTION

1. Field of the Invention

The present invention relates to a solution casting apparatus and a solution casting method.

2. Description Related to the Prior Art

A polymer film (hereinafter, film) is used as an optical functioning film in several fields, since being excellent in the optical transparency and the flexibility and being to be smaller in weight and thickness. In the polymer film, there is a cellulose acylate film formed from cellulose acylate. For example, especially cellulose triacetate (hereinafter TAC) film is formed from TAC whose averaged acetylation degree is in the range of 57.5% to 62.5%. The TAC film is used as a film base of a film material, such as a photosensitive material, since having strength and inflammability. Further, the TAC film is excellent in optical isotropy, and therefore used as an optical functional film, such as a protective film of a polarizing filter, an optical compensation film, a wide view film in a liquid crystal display whose market becomes larger in recent years, and the like.

In the film production method, there are a melt extrusion method and a solution casting method. In the melt extrusion method, the polymer is heated to melt, and then the melt polymer is extruded to form a film. The melt extrusion method has merits in that the productivity is high and the cost for equipments is relatively low. However, it is difficult to adjust the film thickness accurately, and streaks (called die line) are easily formed. Therefore, by the melt extrusion method, it is hard to produce the high quality film which can be used as the optical functional film. Further, in the solution casting method, a dope containing the polymer and a solvent is cast onto a support to form a casting film, and the casting film, after having self supporting properties, is peeled as a wet film peeled from the support. The wet film is dried to a film and then the film is wound up. The solution casting method is more excellent in the optical isotropy and the thickness uniformity than the melt extrusion method. Further, in the solution casting method, the produced film contains foreign materials less than in the melt extrusion method. Therefore, the solution casting method is applied to the film production method, especially that for producing the optical functional film.

In recent years, the liquid crystal display becomes thinner, and a display panel thereof becomes wider. Further, since demands for the liquid crystal display increases rapidly, it is required to develop the solution casting apparatus and the solution casting method of producing the film, especially the thin and wide optical functional film at high productivity.

In order to increase the productivity of the solution casting method, the development is made such that the casting speed may be higher. In the solution casting method, the production speed is the lowest at the casting of the dope. Thus the production speed concretely depends on the casting speed. Therefore, if the running speed of the casting becomes higher, the casting speed becomes higher and thus the production speed (namely the productivity) also becomes higher. However, in accordance with the increase of the running speed of the support, especially in case that the running speed becomes 50 m/min or more, the adhesivity of the casting film to the support becomes lower. In this case, when the entrained air caused by the running of the support enters into a space between the casting film and he support, which causes the defect of thickness unevenness. Therefore, in order to compensate for the decrease of the adhesivity, it is necessary to decompress the upstream area (hereinafter a bead rear side) from the dope bead.

However, when the pressure in the dope bead rear side is more than 100 Pa lower than other area (namely in a downstream area from the dope bead in the running direction of the support), the dope bead vibrates and therefore becomes unstable, which causes the thickness unevenness.

Further, when it is designated to produce the thin film, the dope bead must be thin, and when it is designated to produce the wide film, the dope bead must be wide. However, in order to produce the thin film or the wide film, the vibration of the dope bead easily occurs, which causes the thickness unevenness.

In order to make the dope bead stable, a solution supplying method is applied to the solution casting method, such that the drying of the dope bead may be prevented. When it is designated to make the solution supplying method, the flexible situation is kept, or a clearance between an outlet for discharging the casting dope and the support is made smaller.

In the solution supplying method, a solvent dissolvable of the dope is supplied to the discharged dope or the dope bead. As described in Japanese Patent No. 2,687,260, a dope of a cellulose triacetate and the like is cast from a casting die, and a solvent which is dichloromethane and the like is supplied to both side edges of the discharged casting dope. Thus the occurrence of the skinning as a gelation of the dope is prevented.

However, even if the solution supplying method is applied to the solution casting method, the skinning occurred after the casting for more than 1,000 hours, for example. In this case, the casting speed must be reduced to the value in which the cutting of the casting film doesn't occur, and then the skinning must be removed. Further, the dope to be used in the solution casting method contains compounds having high inflammability and high ignitability, and therefore the atmosphere in the casting room is changed to the nitrogen gas for the preventing the explosion. While the removal of the skinning is performed, the atmosphere in the casting chamber must be changed to the outside air, and after the removing the skinning, the atmosphere must be change to the nitrogen gas again. Thus the productivity becomes low.

Further, there is usually a protrusion on the outlet. Therefore, if the clearance between the outlet and the support is smaller, the protrusion contacts to and scratches the support. Thus the scratch on the support is sometimes signed onto the casting film, which causes the surface defect of the film. Further, the casting die and the support are usually made of stainless since it is required in the point of the conditions of the casting process that they have the corrosion resistance and the low thermal expansion. Thus, it is necessary to prevent the damage made by contacting of the protrusion to the support and to make the clearance between the outlet and the support. Therefore, the member forming the slit is an inner deckle plates formed of Teflon (trademark).

In the researches and keen examinations, the inventor found that when the inner deckle plate is not formed of Teflon but a material whose volume change is at most a predetermined value, the dope bead becomes stable and the occurrence of the skinning is prevented even at the high film production speed.

### SUMMARY OF THE INVENTION

An object of the present invention is to provide a solution casting apparatus and a solution casting method in which the thin and wide film can be produced at high productivity.

In order to achieve the object and the other object, in a solution casting method of the present invention, a casting device is provided for flowing out from a slit a dope containing a polymer, and includes a pair of first slit members forming first walls of the slit and a pair of second slit member forming second walls of the slit, while the first walls extends in a lengthwise direction of the slit and the second walls extends in a widthwise direction of the slit. A protrusion length of a protrusion is at most 9 μm upon providing for the second slit member with the protrusion protruding from the first slit member in a flow-out direction of the dope or for the first slit member with the protrusion protruding from the second slit member in the flow-out direction. The casting film is peeled from the support, and the peeled casting film is dried to a film. A support is continuously run, and the dope is flown out from the outlet so as to form a casting film on the support while the dope forms a dope bead between the outlet and the support. The decompressing is made in an upstream area from the dope bead in a running direction of the support. The casting film is peeled from the support and dried to a film.

Preferably, the decompression is made such that a pressure in the upstream area from the dope bead may be in the range of 100 Pa to 1000 Pa lower than that of a downstream area from the dope bead in the running direction.

Preferably, a film thickness of the film is in the range of 20 μm to 70 μm.

Preferably a width of the film is at most 1.5 m and at most 3 m. Preferably, a running speed of the support is in the range of 50 m/min to 200 m/min.

Preferably the support is a casting drum or a casting belt.

A solution casting apparatus of the present invention includes a casting device for flowing from a slit a dope containing a polymer and a solvent so as to form a casting film onto the support, and the casting device includes a pair of first slit members forming first walls of the slit and a pair of second slit member forming second walls of the slit, while the first walls extends in a lengthwise direction of the slit and the second walls extends in a widthwise direction of the slit. A protrusion length of a protrusion is at most 9 μm upon providing for the second slit member with the protrusion protruding from the first slit member in a flow-out direction of the dope or for the first slit member with the protrusion protruding from the second slit member in the flow-out direction. Further, the solution casting apparatus includes a continuously running support for receiving a dope bead formed by the dope flowing out from the slit, a decompression chamber for decompressing in an upstream area from the dope bead, and a drying device for drying the casting film peeled from the support such that a film may be obtained.

Preferably, the decompression is made such that a pressure in the upstream are from the dope bead may be in the range of 100 Pa to 1000 Pa lower than that of a downstream area from the dope bead in the running direction.

Preferably, a film thickness of the film is in the range of 20 μm to 70 μm.

Preferably a width of the film is at least 1.5 m and at most 3 m. Preferably a running speed of the support is in the range of 50 m/min to 200 m/min.

Preferably the support is a casting drum or a casting belt.

According to the solution casting method and the solution casting apparatus of the present invention, even if the aspiration is made such that the upstream area may be at most 100 Pa lower than the downstream area, the vibration of the casting bead that causes the thickness unevenness and the like is reduced. Therefore the thin and wide optical functional film can be produced effectively. Further, even if the solution casting is performed for a long time, the generation of the skinning is reduced. Therefore it is prevented that the removing the skinning decreases the productivity, and the thickness unevenness and the scratches are reduced.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a dope production line for producing a primary dope;

FIG. 2 is a flow chart of a film production from the primary dope;

FIG. 3 is a schematic diagram of a film production line for producing a film from the primary dope;

FIG. 4 is a sectional view of a first embodiment of a casting die in the film production line;

FIG. 5 is a sectional view of the casting die along a line V-V in FIG. 4;

FIG. 6 is a perspective view of a die lip of the casting die;

FIG. 7 is a plan view of a lower side of the casting die;

FIG. 8 is an explanatory view of aspirating the air in a space of a rear face side of a dope bead formed between the casting die and a casting drum as a support;

FIG. 9 is a sectional view of a second embodiment of a casting die in the film production line;

FIG. 10 is a sectional view of a third embodiment of a casting die in the film production line;

FIG. 11A is a side view of the casting die at adjusting the distances CL1-CL4 between the lip plates and the inner deckle plates; and

FIG. 11B is a side view of the casting die after adjusting the distances CL1-CL4.

### PREFERRED EMBODIMENTS OF THE INVENTION

In followings, the preferred embodiments will be explained in detail. However, the present invention is not restricted in the description.

[Raw Material]

(Polymer)

As polymer of this embodiment, the already known polymer to be used for the film production may be used. For example, cellulose acylate is preferable, and triacetyl cellulose (TAC) is especially preferable. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

2.5≦A+B≦3.0 (I)

0≦A≦3.0 (II)

0≦B≦2.9 (III)

Further, polymer to be used in the present invention is not restricted in cellulose acylate.

A glucose unit constructing cellulose with β-1, 4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly 2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. The percentage is preferably at least 25%, particularly at least 30%, and especially at least 33%. Further, DSA+DSB of the 6^{th} position of the cellulose acylate is preferablyat least 0.75, particularlyat least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability. Note that the dope contains a polymer and a solvent for dissolving the polymer. Further, if necessary, an additive is added to the dope.

The cellulose as the raw material of the cellulose acylate may be obtained from one of the pulp and the linter.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

(Solvent for Dope)

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent. It is to be noted in the present invention that the dope is a polymer solution or a dispersion that is obtained by dissolving or dispersing the polymer in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 wt. % to 25 wt. %, and particularly in the range of 5 wt. % to 20 wt. %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 carbons, and alcohols having 1 to 12 carbons are preferable, and a mixture thereof can be used adequately. For example, there is a mixture of methyl acetate, acetone, ethanol and n-butanol. These ethers, ketones, esters and alcohols may have the ring structure. Further, the compounds having at least two of functional groups in ethers, ketones, esters and alcohols (namely, —O—, —CO—, —COO— and —OH) can be used for the solvent.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additive materials of the additive (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148

[Dope Production Method]

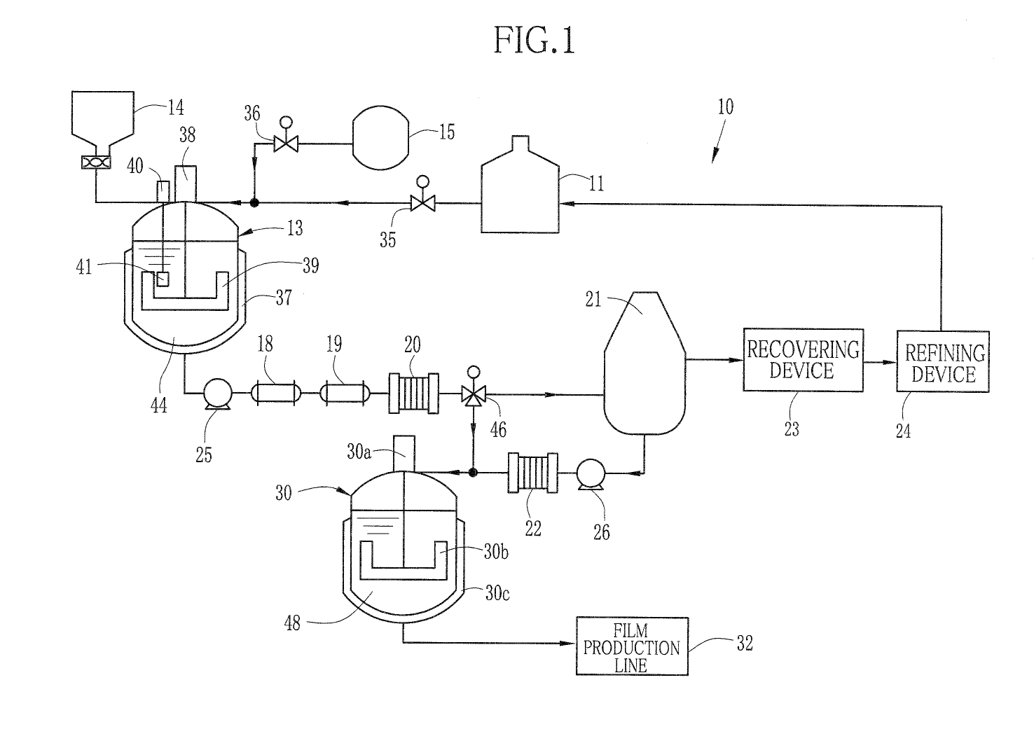

The dope is produced from the above raw materials. As shown in FIG.1, a dope production line 10 is constructed of a solvent tank 11 for storing a solvent, a mixing tank 13 for mixing the TAC and the solvent therein, a hopper 14 for supplying the TAC and an additive tank 15 for storing an additive. Further, there is a heating device 18 for heating a swelling liquid (described below in detail), a temperature controller 19 for controlling the temperature of a prepared dope, and a filtration device 20. Further, there are a flushing device 21 for concentrating the dope and a filtration device 22. Further, there area recovering device 23 for recovering a solvent vapor, and a refining device 24 for recycling the recovered solvent. The dope production line 10 is connected to a film production line 32.

In the dope production line 10, a primary dope 48 is produced in the following order. A valve 35 disposed on a pipe connecting the solvent tank 11 to the mixing tank 13 is opened such that the solvent in the solvent tank 11 may be sent to the mixing tank 12.

Then the TAC in the hopper 14 is sent to the mixing tank 12 with measuring the amount thereof. Thereafter, a valve 36 is opened and closed such that a necessary amount of the additive may be sent from the additive tank 15 to the mixing tank 13.

The method of feeding the additive to the mixing tank is not restricted in the above description. If the additive is in the liquid state in the room temperature, it may be fed in the liquid state to the mixing tank 13 without preparing for the additive solution. If plural sorts of additive compounds are used, the additive containing the plural additive compounds may be accumulated in the additive tank 15 altogether. Otherwise plural additive tanks may be used so as to contain the respective additive compounds, which are sent through independent pipes to the mixing tank 13.

In the above explanation, the solvent, the TAC, and the additive are sequentially sent to the mixing tank 13. However, the sending order is not restricted in it. For example, after the predetermined amount of the TAC is sent to the mixing tank 13, the feeding of the predetermined amount of the solvent and the additive may be performed to obtain a TAC solution. Otherwise, it is not necessary to feed the additive to the mixing tank 13 previously, and the additive may be added to a mixture of TAC and solvent in following processes.

The mixing tank 13 is provided with a jacket 37 covering over an outer surface of the mixing tank 13, a first stirrer 39 to be rotated by a motor 38, and a second stirrer 41 to be rotated by a motor 40. The mixing tank 13 stores a mixture liquid 44 obtained by mixing the solvent, the TAC and the additive. Further, the first stirrer 39 preferably has an anchor blade, and the second stirrer 41 is preferably an eccentric stirrer of a dissolver type.

The inner temperature in the mixing tank 13 is controlled by a heat transfer medium in the jacket 37. The preferable inner temperature is in the range of −10° C. to 55° C. Note that the selection of the first stirrer 39 and the second stirrer 41 is made in accordance with the conditions of the dope preparation.

A pump 25 is driven such that the mixture liquid 44 in the mixing tank 13 may be sent to the heating device 18 which is preferably a pipe with a jacket. The heating device 18 may be preferably provided with a pressuring device so as to progress the dissolution effectively. When the heating device 18 is used, the dissolution of solid compounds proceeds under the heating or the heat-pressurizing conditions such that a dope maybe obtained. This method is called a heat-dissolution method. The temperature of the mixture liquid 44 is preferably in the range of 0° C. to 97° C.

In order to dissolve the TAC to the solvent sufficiently, it is preferable to perform not only the heat-dissolution method but also a cool-dissolution method.

The heated mixture liquid 44 is sent to a temperature controller 19 to control the temperature of the mixture liquid 44 nearly to a room temperature. Then the filtration of the dope is made in the filtration device 20, such that impurities and undissolved materials may be removed from the dope. The filter material of the filtration device 20 preferably has an averaged nominal diameter of at most 100 μm. The flow volume of the filtration in the filtration device 20 is preferably at least 50 liter/hr. The dope after the filtration is fed through a valve 46 and thus stored as the primary dope 48 in a stock tank 30.

The dope can be used as the primary dope 48 for a film production, which will be explained. However, in the method in which the dissolution of TAC is performed after the preparation of the mixture liquid 44, if it is designated that a dope of high concentration is produced, the time for production of such dope becomes longer. Consequently, the production cost becomes higher. Therefore, it is preferable that a dope of the lower concentration than the predetermined value is prepared at first and then the concentrating of the dope is made. In this embodiment, the dope after the filtration is sent to the flushing device 21 through the valve 46. In the flushing device 21, the solvent of the dope is partially evaporated. The solvent vapor generated in the evaporation is condensed by a condenser (not shown) to a liquid state, and recovered by the recovering device 23. The recovered solvent is recycled by the refining device 24 and reused. According to this method, the decrease of cost can be designated, since the production efficiency becomes higher and the solvent is reused.

The dope after the concentrating as the above description is extracted from the flushing device 21 through a pump 26. Further, in order to remove bubbles generated in the dope, it is preferable to perform the bubble removing treatment. As a method for removing the bubble, there are many methods which are already known, for example, an ultrasonic irradiation method and the like. Then the dope is fed to the filtration device 20, in which the undissolved materials are removed. Note that the temperature of the dope in the filtration device 20 is preferably in the range of 0° C. to 200° C.

The dope after the filtration is stored as the primary dope 48 in the stock tank 30, which is provided with a stirrer 30b rotated by a motor 30a. Thus the produced dope preferably has the TAC concentration in the range of 5 wt. % to 40 wt. %.

Note that the method of producing the primary dope 48 is disclosed in detail in [0517] to [0616] in Japanese Patent Laid-Open Publication No. 2005-104148, for example, about the dissolution method and the adding methods of the materials, the raw materials and the additives in the solution casting method for forming the TAC film, the filtering method, the bubble removing method, and the like. The description is also applied to the present invention.

[Film Production Process]

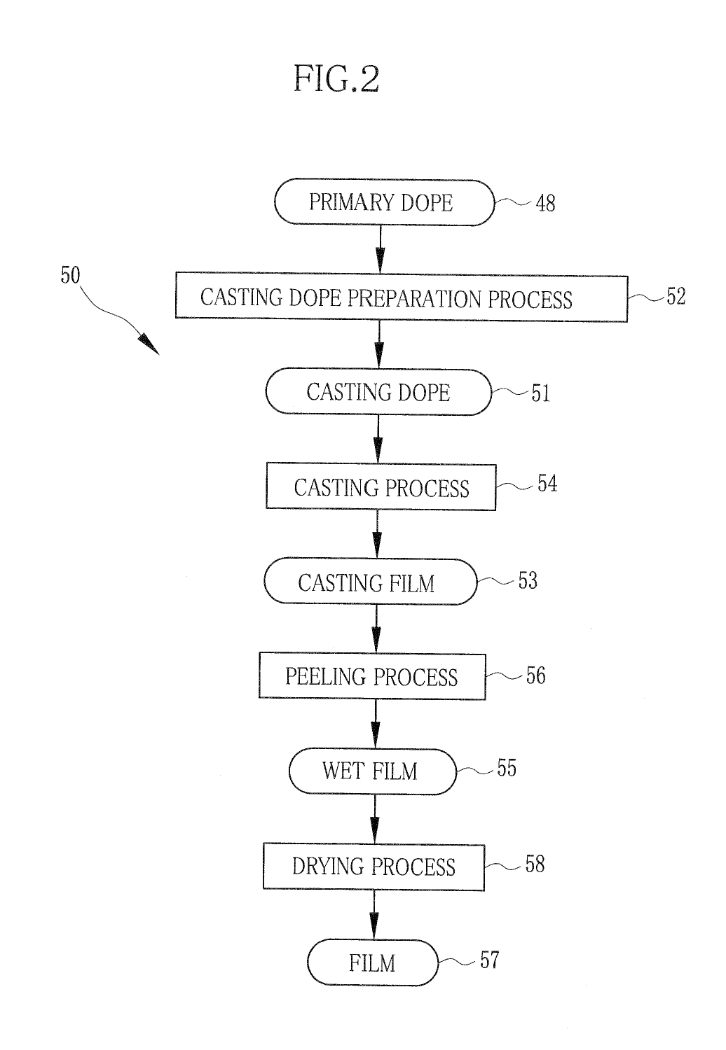

The film production process will be explained. As shown in FIG. 2, a film production process 50 includes a casting dope preparation process 52, a casing process 54, a peeling process 56, and a drying process 58 In the dope preparation process 52, a casting dope 51 is prepared from the primary dope 48 which is obtained in the dope production line of FIG. 1. In the casting process 54, the casting of the casting dope 51 is made such that a casting film 53 may be obtained. In the peeling process 56, the casting film 53 is peeled as a wet film 55. In the drying process 58, the wet film 55 is dried to be a film 57. Note that the film production process 50 further has a winding process in which the film 57 is wound up to a film roll.

[Solution Casting Method]

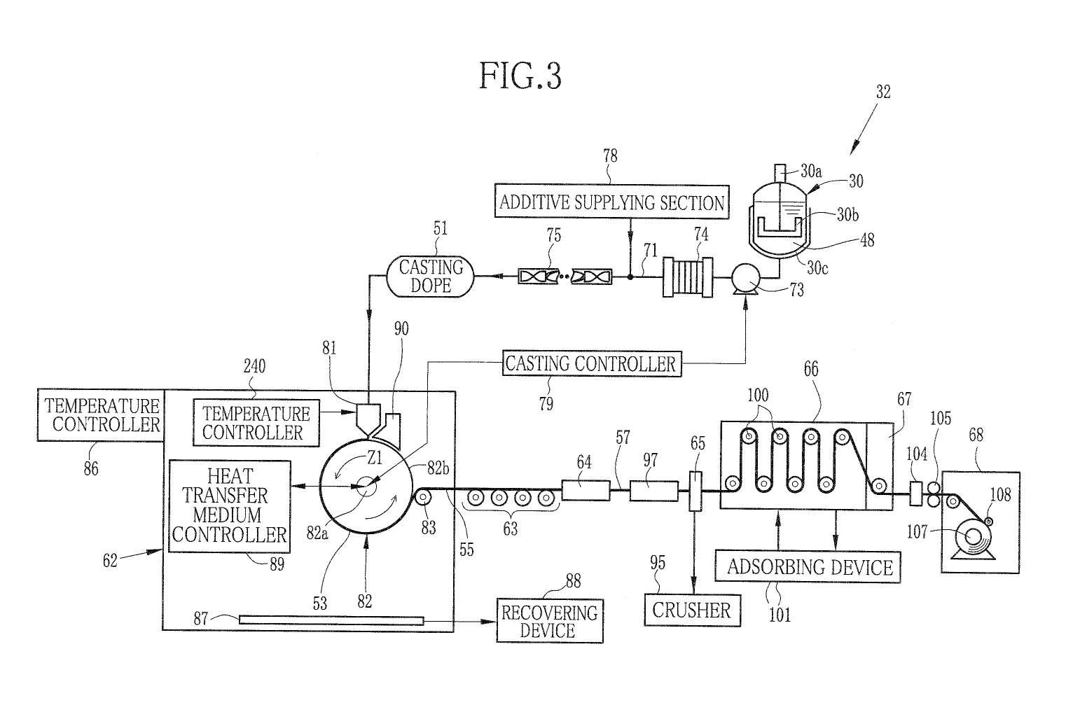

An embodiment of the solution casting method will be described in reference with FIG. 3, now. However, the present invention is not restricted in the embodiment. As shown in FIG. 3, the film production line 32 includes a casting chamber 62, a plurality of path rollers 63, a pin tenter 64, an edge slitting device 65, a drying chamber 66, a cooling chamber 67, and a winding chamber 68.

The stock tank 30 is provided with a motor 30a, a stirrer 30b to be rotated with the motor 30a, and a jacket 30c. In the stock tank 30, the primary dope 48 is stored. In to the jacket 30c, a temperature controlling medium (not shown) is supplied to control the inner temperature of the stock tank 30, and the stirrer 30b is rotated. Thus the aggregation of the polymer and the like is reduced such that the primary dope 48 may be uniform in the stock tank 30.

The stock tank 30 is connected to the casting chamber 62 through a pipe 71 on which there are a gear pump 73, a filtration device 74 and a static mixer 75. In the upstream side from the static mixer 75, an additive supplying section 78 is connected to the pipe 71 for feeding an additive compounds (predetermined amount of UV absorbing agent, matting agent and retardation agent and the like) or a polymer solution (hereinafter a mixture additive) containing the additive compounds.

The gear pump 73 is connected to a casting controller 79. Thus the casting controller 79 controls the drive of the gear pump 73 so as to feed the primary dope 48 at a predetermined flow volume from the stock tank 30 to a casting die 81 provided in the casting chamber. The additive compounds or the polymer solution is added to the primary dope 48 fed through the pipe 71. Thereafter the mixing of the primary dope 48 is made by the static mixer, such that the casting dope 51 may be obtained.

The casting chamber 62 includes the casting die 81, a casting drum 82 to be rotated in a rotary direction Z1, a peel roller 83, a temperature controller 86, a condenser 87, a recovering device 88, and a decompression chamber 90 for aspirating an atmosphere in the casting chamber 62. In the casting chamber 62, the casting dope 51 is cast from the casting die 81 onto the casting drum 82 so as to form the casting film 53. Then the casting film 53 is peeled as the wet film 55 with support of the peel roller 83. The inner temperature of the casting chamber 62 is controlled in a predetermined range by the temperature controller 86, and the solvent vapor generated by the evaporation of the solvent in the casting chamber 62 is condensed by the condenser 87, and thereafter recovered by the recovering device 88. The recovered solvent is reused as the solvent for preparing the dope. Thus the recovering device 88 keeps the vapor pressure of the solvent contained in the atmosphere in the casting chamber 62 to a predetermined value.

(Casting Drum)

The casting drum 82 is disposed below the casting die 81, and has a drum shaft 82a which is connected to the casting controller 79. Thus the casting controller 79 also controls the rotation speed of the casting drum 82 in a rotary direction Z1, such that a speed of a periphery 82b of the casting drum 82 to the casting die 81 may be a predetermined value.

In order to control the surface temperature of the casting drum 82 to a predetermined value, it is preferable to provide a heat transfer medium circulator 89. The heat transfer mediums whose temperatures are controlled by the heat transfer medium circulator 89 pass through paths (not shown). Thus the temperature T1 of the periphery 82b of the casting drum 82 is kept to the predetermined values.

The width of the casting drum 82 is not restricted especially. However, the width of the casting drum 82 is preferably 1.1 to 2.0 times as large as the casting width. The periphery is preferably grind such that surface roughness of the periphery 82b is preferably at most 0.01 μm. Further, it is preferable that the surface defect on the periphery 82b must be reduced to be minimal. Concretely there are no pin hole of at least 30 μm, at most one pin hole at least 10 μm and less than 30 μm, and at most two pin holes of less than 10 μm per 1 m².

The material of the casting drum 82 is preferably stainless, and especially SUS 316 such that the casting drum 82 may have the enough resistance to corrosion and the strength. On the periphery 82b, it is preferable to make the chrome coating. Thus the periphery 82b has the enough resistance to corrosion and the strength.

(Peel Roller)

The peel roller is disposed in the downstream side from the casting die 81 in the rotary direction Z1 so as to be close to the periphery 82b. When the casting film 53 is peeled as the wet film 55 from the casting drum 82, the peel roller 83 supports the wet film 55. Further, the decompression chamber 90 is disposed from a peeling point at which the peeling is made to a casting point at which the casting is made, so as to be close to the periphery 82b of the casting drum 82.

In a downstream from the casting chamber 62 are disposed a plurality of path rollers 63, the pin tenter 64, and the edge slitting device 65.

The path rollers support and guide the wet film 55 to the pin tenter 64, after the wet film 55 is fed out from the casting chamber 62. Note that there is an air feeder (not shown) near the path rollers. Thus the air feeder feeds out a drying air to the wet film 55 on the path rollers 63, so as to dry the wet film 55.

The pin tenter 64 includes a plurality of pins (not shown) as a holding member for holding the wet film 55. The pins are attached to a circular chain, and endlessly move in accordance with the running of the chain. In the pin tenter 64, many pins are inserted into both side edge portions near an entrance. Thus both side edge portions are held by the pins, and transported. In the pin tenter 64, there is an air blower (not shown) for feeding a drying air to the wet film 55. Thus the content of remaining solvent in the wet film 55 is decreased while wet film 55 is transported in the pin tenter 64. Near the exit of the pin tenter 64, the pins are removed from both side edge portions of the film 57.

The film 57 is fed to the edge slitting device 65, and both side edge portions are slit off. The edge slitting device 65 is connected with a crusher 95, and the tips of the both side edge portions are crushed by the crusher 95. Note that the tips crushed by the crusher 95 are reused as tips for the dope preparation.

Note that there may be a clip tenter 97 for drying the film 57 between the pin tenter 64 and the edge slitting device 65. The clip tenter 97 is a drying device which includes a plurality of clips as clipping member of both side edge portions of the film 57. The clip tenter 97 stretches the film 57 under a predetermined condition, so as to provide a predetermined optical property for the film 57.

In the drying chamber 66, there are many rollers 100 and an adsorbing device 101. The film 57 is transported into a cooling chamber 67, and cooled down. In the downstream side from the cooling chamber, there is a compulsory neutralization device (or a neutralization bar) 104 for eliminating the charged electrostatic potential of the film 57 to the predetermined value. Further, in this embodiment, there is a knurling roller 105 for providing a knurling to the film 57 in the downstream side of the compulsory neutralization device 104.

The inner temperature of the drying chamber 66 is riot restricted especially. However, it is preferable in the range of 50° C. to 160° C. In the drying chamber 66, the film 57 is transported with lapping on many rollers 100. The solvent vapor evaporated from the film 57 by the drying chamber 66 is adsorbed by the adsorbing device 101. The air from which the solvent components are removed is reused for the drying air in the drying chamber 66. Note that the drying chamber 66 preferably has plural partitions for variation of the drying temperature. Further, a pre-drying device (not shown) is provided between the edge slitting device 65 and the drying chamber 66, so as to perform the pre-drying of the film 57. Thus it is prevented that the temperature of the film 57 increases rapidly, and therefore the change of the shape of the film 57 is reduced.

The film 57 is transported toward the cooling chamber 67, and cooled therein to around the room temperature. A humidity control chamber (not shown) may be provided for conditioning the humidity between the drying chamber 66 and the cooling chamber 67. Preferably, in the humidity control chamber, an air whose temperature and humidity are controlled is applied to the film 57. Thus the curling of the film 57 and the winding defect in the winding process can be reduced.

Thereafter, the compulsory neutralization device (or neutralization bar) 104 eliminates the charged electrostatic potential of the film 57 to the predetermined value (for example, in the range of −3 kV to +3 kV). After the neutralization, the embossing of both side portions of the film 57 is made by the embossing rollers to provide the knurling. The emboss height from the bottom to the top of the embossment is in the range of 1 μm to 200 μm.

In the winding chamber 68, there are a winding shaft 107 and a press roller 108. Thus the film 57 is wound by the winding shaft 107 in the winding chamber 68. At this moment, a tension is applied at the predetermined value to the press roller 108.

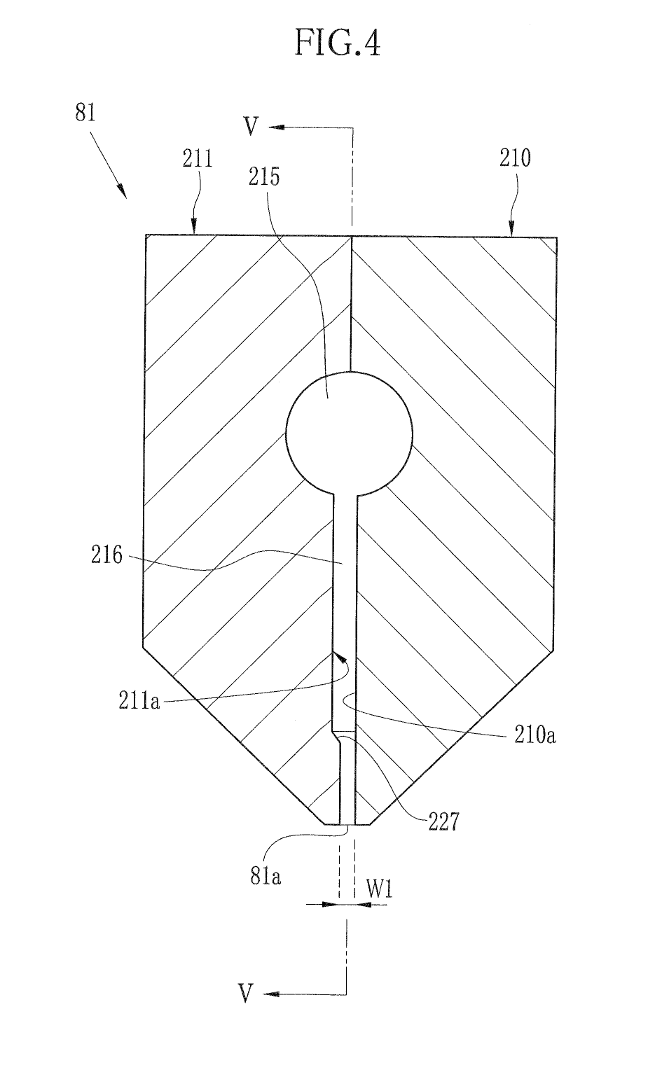

As shown in FIG. 4, the casting die 81 has lip plates 210, 211, and a circular manifold 215 which is formed on a center of a side face of the casting die 210 while the side face is constructed by combining the lip plates 210, 211. In a lower side from the manifold 215, a slit 216 is formed between the lip plates 210, 211, so as to continue to the die outlet 81a which is extended in a widthwise direction of the drum 82.

The lip plates 210, 211 respectively have contact faces 210a, 211a. Further, the contact face 211a has an inclination 227, such that the clearance W1 of the slit 216 may be smaller in a downstream side of the slit 216.

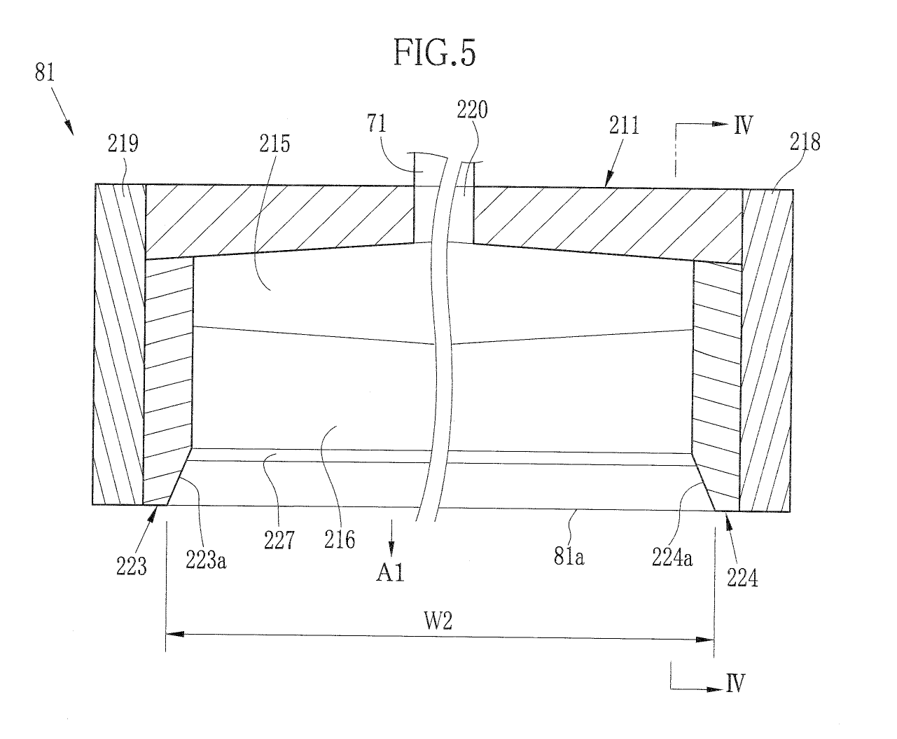

In FIGS. 5 & 6, the casting die 81 has side plates 218, 219 which are disposed in respective side of the lip plates 210, 211, and packings (not shown) are disposed between the lip plate 210 and each of the side plates 218, 219 and between the lip plate 211 and each of the side plates 218, 219, so as to firmly attach the lip plates 210, 211 to the side plates 218, 219.

The shape of the manifold 215 is a coat hanger type. The manifold 215 has a dope entrance 220 connected with a pipe 71. Further, the casting die 81 has inner deckle plates 223, 224 which are disposed in both sides of the manifold 215 and the slit 216 such that the inner deckle plates 223, 224 may firmly contact to the packing.

The lip plates 210, 211 and the inner deckle plates 223, 224 respectly has contact faces 210a, 211a, 223a, 224a which are walls of the manifold 215, the slit 216, and the die outlet 81a. Note that the contact face 224a extends to an opposite direction to the flowing direction of the casting dope 51, and an upper end 224z (FIG. 4) is positioned in the slit 216. However, the present invention is not restricted in it. The upper end 224z may be positioned on an upper end or a lower end of the manifold. Further, if the lip plates 210, 211 are firmly adhered to the side plates 218, 219 and further if the manifold 215 and the slit 216 and the like are closed enough, the packing may not be used.

After fed into the casting die 81, the casting dope 51 is guided into the manifold 215, flows through the slit 216, and is fed out from the die outlet 8la. Therefore the contact faces 210a, 211a contact to the casting dope 51 flowing through the slit 216.

In FIG. 4, the lip plates 210, 211 respectively have contact faces 210a, 211a. Further, the contact face 211a has an inclination 227, such that the clearance W1 of the slit 216 may be smaller in a downstream side of the slit 216.

In FIG. 5, a distance W2 between the contact faces 423a and 424a is defined as a flow width of the casting dope 51. The distance W1 is almost constant entirely in the manifold 215, and becomes larger at a predetermined rate in a lower part of the slit 216 near the outlet 81a. Thus, the contact faces 223a, 224a of the inner deckle plates 223, 224 have in the lower end portion an inclination face inclined to an outside in a widthwise direction of the casting die 81. Since each contact faces 223a, 224a are provided with the inclination face, the both side edge portions of the dope bead of the discharged casting dope becomes thinner, and therefore the edge defect is prevented. Note that the inclination surface is corresponding to a widening surface of the present invention.

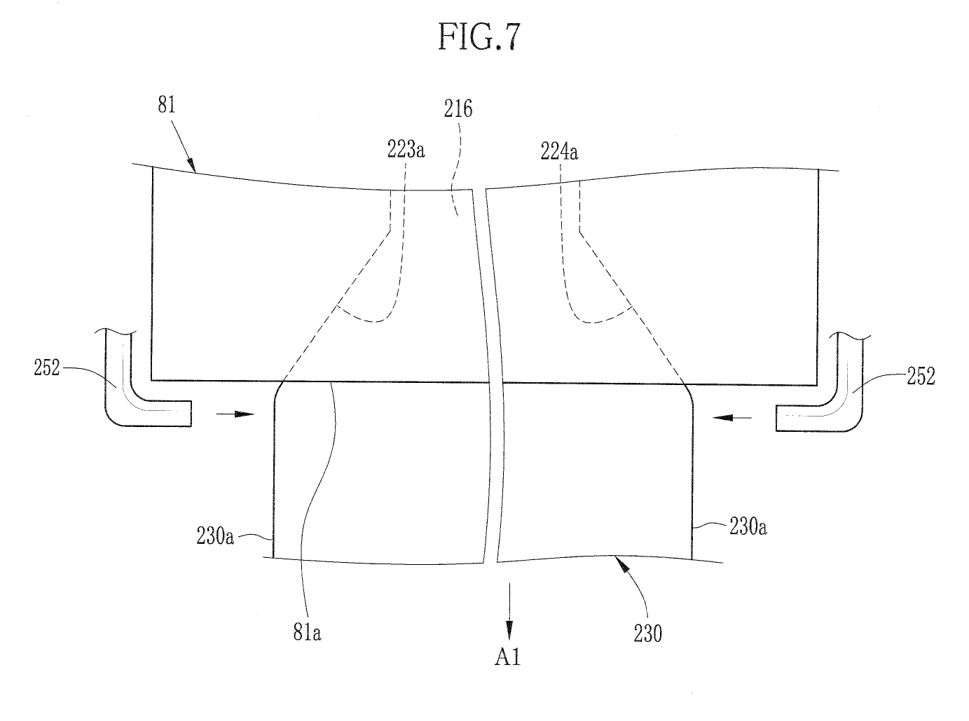

The casing dope 51 flowing in the slit 216 is fed out from the die outlet 81a in the discharging direction A1, so as to form the dope bead 230 (see, FIG. 7).

In order to know the discharging direction A1 concretely, there are several two methods. In the first method, a tracer material is added into the casting dope 51, and the trace of the tracer material is observed. In the second method, a photoelastic device observes the streaming birefringence so as to obtain a surface of uniform shear stress.

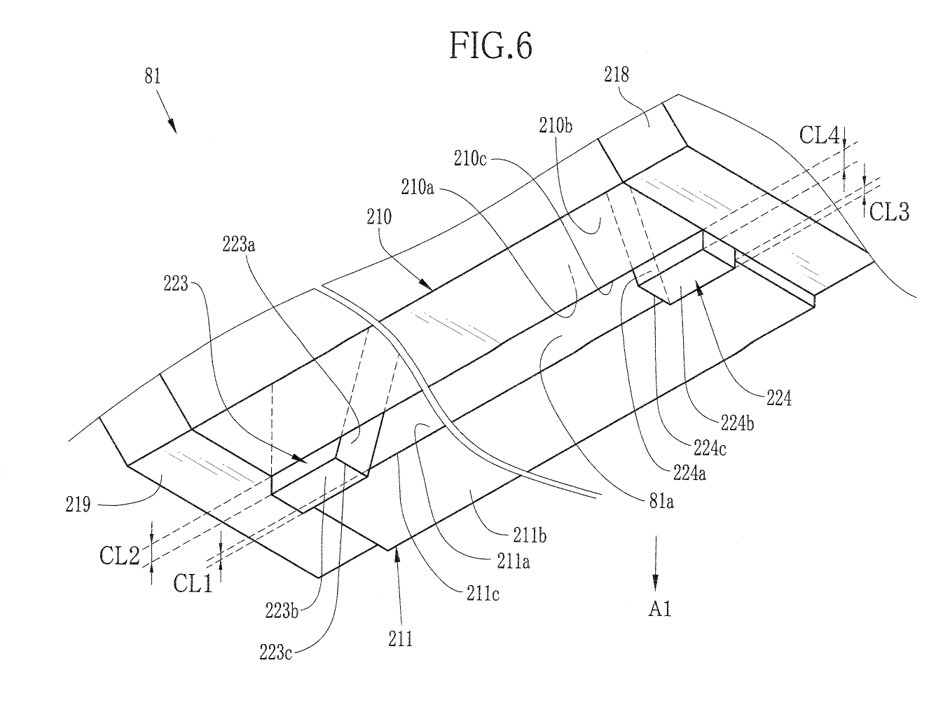

As shown in FIG. 6, the lip plates 211 and the inner deckle plates 223 respectively have end faces 211b, 223b. The contact face 211a and the end face 211b of the lip plate 211 forms a ridge 211c, and the contact face 223a and the end face 223b of the inner deckle plate 223 forms a ridge 223c. Ideally, lower ends of the inner deckle plate 211 are disposed on an ideal face, which means that there are no protrusions of the lower ends on the die outlet of the casting die 81. However, it is too difficult to dispose the lip plate 211 and the inner deckle plate 223 in the ideal manner. In the actual die production, the lower end of the inner deckle plate 211 usually forms a protrusion on the die outlet. Thus, in the present invention, the protrusion is reduced to be at most a predetermined value. Concretely, a distance CL1 between the ridge 211c and the ridge 223c is at most 9 μm. In the side of the outlet 41a, the lip plate 210 and the inner deckle plate 224 respectively have an end face 210b and an end face 224b which are the most downstream faces in the passage of the casting dope 51. Further, the contact face 210a and the end face 210b of the lip plate 210 forms a ridge 210c, and the contact face 224a and the end face 224b of the inner deckle plate 224 forms a ridge 224c. It is also too difficult to position the lower ends of the lip plate 210 and the inner deckle plate 223 in the ideal manner. In the actual die production, the lower end of the inner deckle plate 223 forms a protrusion on the die outlet. Thus in the present invention, the protrusion is reduced to be at most a predetermined value. Concretely, a distance CL2 between the ridge 210c and the ridge 224c is at most 9 μm. Further, a distance CL3 between the ridge 211c and the 224c and a distance CL4 between the ridge 210c and the ridge 223c are also at most 9 μm.

(Material)

The materials to be used for producing the lip plates 210, 211 and the inner deckle plates 223, 224 in the casting die 81 preferably have resistance to the oxidization and the corrosion which the contact to the casting dope 51 causes. Further, in order to keep the distances CL1-CL4 in the predetermined range, it is preferable that the size variation hardly occurs in the casting process. Thus the materials for the lip plates 210, 211 and the inner deckle plates 223, 224 preferably have the following characteristics:

(1) the corrosion resistance is the same as SUS316 in the compulsory corrosion experiment in an electrolyte water solution,

(2) the pitting (or pitting corrosion) does not occur on the gas-liquid interface even if this material were dipped in a mixture liquid of dichloromethane, methanol and water for three months, and

(3) the coefficient of thermal expansion is at most 2×10⁻⁵ (° C.⁻¹)

Therefore, the materials for the lip plates 210, 211 and the inner deckle plates 223, 224 are preferably a stainless and a ceramics.

According to the contact faces 210a, 211a, 223a, 224a of the lip plates 210, 211 and the inner deckle plates 223, 224, it is preferable that the finish accuracy is at most 1 μm in surface roughness and the straightness is at most 1 μm/m in any direction. When the finish accuracies of the contact faces 210a, 211a, 223a, 224a satisfy the above condition, the formation of the streak and the unevenness on the casting film is prevented. The smoothness of the faces 210b, 211b, 223b, 224b is preferably at most 2 μm. The clearance of a slit of the casting die 31 is automatically adjustable in the range of 0.5 mm to 3.5 mm. According to an edge of the contact portion of a lip end of the casting die 31 to the casting dope, R (R is chamfered radius) is at most 50 μm in all of a width.

Preferably, a hardened layer is preferably formed on the faces 210b, 211b, 223b, 224b. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and no adhesiveness to the casting die 81. Concretely, there are tungsten carbide (WC), Al₂O₃, TiN, Cr₂O₃, and the like. Especially preferable ceramics is tungsten carbide. Tungsten carbide coating can be made by a spraying method.

A width of the casting die 81 is not restricted especially. However, the width is preferably at least 1.1 times and at most 2.0 times as large as a film width. Further, it is preferable to attach a temperature controlling device (not shown) to the casting die 81, such that the temperature may be kept to the predetermined one during the film production. Furthermore, the casting die 81 is preferably a coat hanger type die. In order to adjust a film thickness, the casting die 81 is preferably provided with an automatic thickness adjusting device. For example, thickness adjusting bolts (heat bolts) are disposed at a predetermined distance in a widthwise direction of the casting die 81. According to the heat bolts, it is preferable that the profile is set on the basis of a predetermined program, depending on feed rate of the pumps (preferably, high accuracy gear pumps), while the film production is performed. Further, the feed back control of the adjustment value of the heat bolts may be made by the adjusting program on the base of the profile of a thickness meter (not shown), such as infrared ray thickness meter and the like. The thickness difference between any two points in the widthwise direction except the side edge portions in the casting film is controlled preferably to at most 1 μm. The difference between the maximum and the minimum of the thickness in the widthwise direction is at most 3 μm, and especially at most 2 μm. Further, the accuracy to the designated object value of the thickness is preferably in 11.5 μm. Further, it is preferable to control the shearing rate of the casting dope 51 in the range of one (1/sec) to 5000 (1/sec).

As shown in FIG. 7, it is preferable to provide near the outlet 81a a nozzle 252 for supplying both side edges 230a of the dope bead 230 with a solution (not shown) which is dissolvable to the dope bead 230. The flow volume (or supply rate) V1 of the solution is in the range of 0.1 mL/min to 1.0 mL/min, in order to prevent that the produced film contains the foreign materials. Further, the pulsating rate is preferably at most 5%. The most adequate value of the flow volume Vi changes depending on the running speed of the periphery 82b (or the casting speed), the thickness of the casting dope to be cast, and the like. Therefore the flow volume V1 is preferably adjusted so as to be the most adequate value under each production condition. In this case, the locally proceeding of the drying is reduced on the side edges 230a, and thus the generation of the skinning is prevented. Furthermore, the side edges 230a and other part of the dope bead 230 thereto become flexible, and therefore the flattering of the side edges 230a that is caused by the entrained air or the decompression is reduced. As a result, the dope bead 230 becomes stable.

If the solution cannot be supplied to the side edges 230a directly, it is preferable to supply the solution near the side edges 230a, namely near the contact line of three phases that is formed by a die lip end and the atmosphere.

(Solution)

The solution 250 is preferably a mixture of a poor solvent and a poor solvent of a polymer. In order to know whether the solvent is the good solvent or the poor solvent to the polymer, the solvent is mixed with the polymer such that the weight percentage of the polymer to total weight of the solvent and the polymer may be 5 wt. %. If some material does not dissolve in the mixture, the solvent is the poor solvent. If the polymer entirely dissolves, the solvent is the good solvent.

(Good Solvent)

If the polymer is the cellulose acylate, the good solvent components to be used are preferably aromatic hydrocarbons (for example benzene, toluene and the like), hydrocarbon halides (for example, dichloromethane, chlorobenzene and the like) esters (for example, methyl acetate, ethyl acetate, propyl acetates), and ethers (for example, tetrahydrofuran, methyrene cellosolve and the like). Among them, it is preferable to use the hydrocarbon halide having carbon atoms whose number is in the range of 1 to 7, and especially preferable to use dichloromethane.

(Poor Solvent)

If the polymer is the cellulose acylate, the poor solvent components to be used are preferably alcohols (for example methanol, ethanol, n-propanol, n-butanol, diethylene glycol and the like), and ketones (for example, acetone, methylethylketone and the like). Among them, it is preferable to use the hydrocarbon halide having carbon atoms whose number is in the range of 1 to 12, and especially preferable to use methanol. Note that each of the good solvent and the poor solvent contained in the solution 250 preferably a mixture of a plurality of solvent components.

(Decompression Chamber)

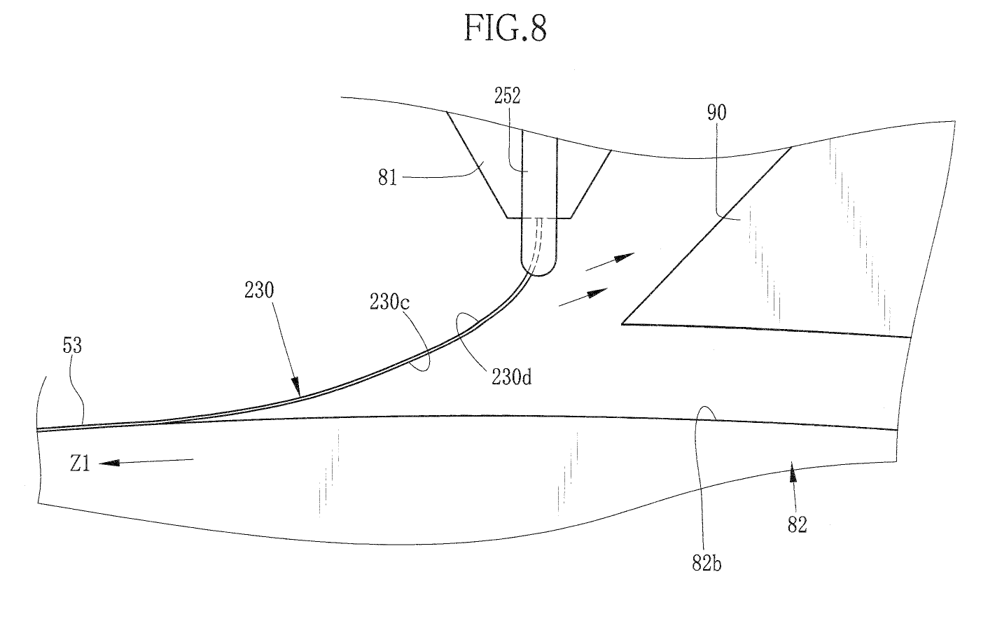

As shown in FIG. 8, the decompression chamber 90 aspirates the airin a upstream side of the rotary direction Z1, such that the pressure in a rear face side of a rear surface 230c of the dope bead 230 is lower in the range of 10 Pa to 2000 Pa than that in another side, namely a front face side of a front face 230d. Thus the dope bead 230 is formed stably.

Further, the decompression chamber 90 is provided with a jacket (not shown), and thus the inner temperature of the decompression chamber 90 may be controlled to a predetermined value. The inner temperature is not restricted especially. However, it is preferable to be lower than the boiling point of the used solvent.

In followings, an example of the method of producing the film 57 will be explained in reference with FIG. 3. In the film production line 32, the primary dope 48 is made uniform by stirring the stirrer 30b. At the stirring, additives such as a plasticizer or the like can be added to the primary dope 48. Further, a heat transfer medium is fed into the jacket 30c, so as to keep the temperature of the primary dope 48 about a predetermined value in the range of 25° C. 35° C.

The casting controller 79 drives the gear pump 73 to feed the primary dope 48 into the pipe 71 through the filtration device 74. In the filtration device 74, the filtration of the primary dope 48 is made. The additives containing a matting agent solution, a UV absorbing agent solution and the like are fed through the additive supplying section 78 to the pipe 71. Then the primary dope 48 is stirred by the static mixer 75 to be the casting dope 51. At the stirring by the static mixer 75, the temperature of the primary dope 48 is preferably about a predetermined value in the range of 30° C. to 40° C. The mixture ratio of the primary dope 48 (D), the matting agent (M) and the UV absorbing agent (U) is not restricted especially. However, the mixture ratio (D:M:U) in the weight percentage is preferably in the range of (90 wt. %:5 wt. %:5 wt. %) to (99 wt. %:0.5 wt. %:0.5 wt. %). Then the casting dope is fed to the casting die 81 in the casting chamber 62 by the drive of the gear pump 73.

The recovering device 88 keeps the vapor pressure of the solvent vapor in the atmosphere of the casting chamber 62 to about a predetermined value. The temperature controller 86 controls the temperature of the atmosphere in the casting chamber to about a predetermined value in the range of −10° C. to 57° C.

A temperature controller 240 connected to the casting die 81 keeps the temperature of a heat transfer medium nearly to 36° C., and the heat transfer medium is fed into a jacket. Thus the temperature of the casting die 81 is kept nearly to 36° C.

Further, the casting controller 79 controls the rotation of the casting drum 82 with the drum shaft 82a. Thus the rotating speed in the rotary direction Z is kept that the moving speed of the periphery may be in the range of 50 m/min to 200 m/min. Further, the heat transfer medium circulator 89 keeps the temperature T1 of the periphery 82b in the range of −10° C. to 10° C.

The casting die 81 discharges the casting dope 51 from the outlet 81a. Thus the casting dope 51 is cast onto the periphery 82b of the casting drum 82 so as to form the casting film 53. Then the casting film 53 is cooled down on the periphery 82b such that the gelation proceeds in the casting film 53. Note that the detailed explanation about the discharging of the casting dope 51 from the outlet 81a will be made later.

The casting film 53, when having the self supporting property, is peeled as the wet film 55 from the casting drum 82 with support of the peel roller 83, and sent by the path rollers 63. Above the path rollers 63, the air blower applies the drying air to the wet film 55 so as dry the wet film 55. Then the wet film 55 is sent to the pin tenter 64.

In the pin tenter 64, both side edge portions are held by the pins at the entrance thereof. Note that a holding member other than the pin may be used. The pins move to convey the wet film 55, while the drying is made under a predetermined condition. Then the holding of the wet film 55 is released and transported out as the film 57 to the clip tenter 97. In the clip tenter 97, both side edge portions of the film 57 are clipped by the clips at the entrance thereof. The clips move to convey the film 57, while the drying and the stretching of the film 57 are made under predetermined conditions.

After the drying is made in the pin tenter 64 and the clip tenter 97 such that the content of the remaining solvent may become to a predetermined value, the film 57 is sent to the edge slitting device 65. In the edge slitting device 65, both side edge portions are slit off from the film 57. The slit side edge portions are sent to the crusher 95 by a cutter blower (not shown), and crushed to tips by the crusher 95.

After the slitting, the film 57 is sent to the drying chamber 66, so as to make the drying moreover. Thus the content of the remaining solvent preferably becomes at most 5 wt. %. About the content of the remaining solvent, it was necessary to sample part of the film 57 and dry the sample. If the sample weight at the sampling was x and the sample weight after the drying was y, the solvent content on the dry basis was calculated in the formula, {(x-y)/y}×100. The film 57 is cooled to a room temperature in the cooling chamber 67.

The compulsory neutralization device 104 was provided, such that in the transportation the charged electrostatic potential of the film might be in the range of −3 kV to +3 kV. Further, the film knurling was made on a surface of each side of the film 57 by the knurling roller 105. Then in the winding chamber 68, the film 57 is wound up around the winding shaft 107 while the press roller 108 applies a tension to the film 57 toward the winding shaft 107. It is preferable that the tension is changed gradually from the start to the eng of the winding.

In the present invention, the length of the film 57 is preferably at least 100 m. The width of the film 57 is preferably at least 600 mm, particularly in the range of 1500 mm to 3000 mm, and especially in the range of 1400 mm to 2500 mm.

Further, the film thickness of the film 57 is preferably in the range of 20 μm to 70 μm.

The explanation of the casting process 54 (FIG. 2) will be made in detail. As shown in FIGS. 7 & 8, the clearance W1 of the slit 216 is adjusted to a predetermined value. The gear pump 73 (see, FIG. 3) is driven such that the casting dope 51 (see, FIG. 3) may flow out from the outlet 81a of the casting die 81 in the flow-out direction A1. Then, the casting dope 51 forms the dope bead 230 between the outlet 81a to the periphery 82b, and forms the casting film 53 on the periphery 82b.

The periphery 82b of the casting drum 82 runs in the running direction Z1 at around a predetermined speed in the range of 50 m/min to 200 m/min. The running of the periphery 82b causes the entrained air which blows near the periphery 82b in the running direction Z1.

The decompression chamber 90 aspirates the air in the rear face side of the dope bead 230, such that the entrained air may be prevented from entering between the casting film 53 and the periphery 82b. By the decompression, the pressure in a rear face side of the dope bead 230 is lower preferably in the range of 100 Pa to 1000 Pa lower than the front face side which is downstream side from the dope bead 230, and particularly in the range of 300 Pa to 800 Pa lower. Note that the pressure difference from the rear face side to the front face side is preferably adjusted in accordance with the running speed of the periphery 82b.

The causality between the value of the distances CL1-CL4 and the generation of the skinning in the casting dope 51 is not known in detail. However, the considerable cause of the relation is explained as follows. When the casting dope 51 of the viscoelastic fluid is discharged through the die outlet 81a, the die-swell phenomena occurs. The reason of the occurrence of the die-swell phenomena is believed as that the elastic shear distortion which usually occurs in the viscoelastic flow through the pipe is recovered near an outlet of the pipe. Thus, in the casting die 81, the recovering of the elastic shear distortion near the die outlet 81a causes the die swell phenomena to change the formation of the casting dope 51. Thus the retaining of the casting dope 51 occurs.

Generally, in the casting die constructed of a pair of the lip plates or a pair of the inner deckle plates, the distances CL1-CL4 are not zero. Therefore, in the lower end of the die lip, the casting dope fed out from the outlet 41a in the flow-out direction A1 contact to only one of the contact faces, while being already apart from the contact face of the opposite side. In this situation, part of the casting dope is contacting to the contact face, and the elastic shear distortion of the part is recovered in effect of the die-swell phenomena. Thus the swelling of the casting dope occurs. Further, another part of the casting dope is apart from the contact face of the opposite side, namely is not contacting to the contact face of the opposite side, the elastic shear distortion is not recovered. Thus, if the partial occurrence of the recovering of the elastic shear distortion continues for a while, the disorder of the flow of the casting dope occurs entirely, so as to cause the retaining of the casting dope contacting to the casting face. Further, the disorder of the casting dope becomes larger depending on the enlargement of the distances CL1-CL4. In the present invention, however, since the distances CL1-CL4 are at most 9 μm, the retaining of the casting dope that is caused by the die-swell phenomena is prevented. Therefore, in the present invention, the flow disorder or the elastic shear distortion of the casting dope 14 flowing through the passage in the casting die 41 is reduced. Consequently, the adhesion and the retaining of the casing dope to the lip plates 210, 211 are prevented, while the adhesion and the retaining usually causes the skinning.

Therefore, the smaller value of the distances CL1-CL4, namely the high evenness on the outlet 81a reduces the change of formation of the casting dope 51. Consequently the adhesion of the casting dope 51 to the outlet 81a and the retention of the casting dope 51 are prevented.

In the present invention, the casting process 54 is performed stably without the occurrence of the skinning, even if the casting speed is increasing. Further, the effects of the present invention are recognized even if the outlet of the casing die or the casting device may have any shape. Therefore, the present invention can be applied also to the casting die having the rectangular outlet in which it is considered that the retaining of the casting dope often occurs. Further, the present invention has not only the effect of reducing the occurrence of the skinning, but also the effects of preventing several elements which have bad influence on the solution casting method. The several elements are, for example, die lines which occurs by the generation of cores of the casting dope on the contact surfaces 210a, 211a, 223a, 224a.

When it is designated to produce the thin film or the wide film, the entrained air occurs, the decompression causes an airflow, and another airflow occurs in the atmosphere. These at least three elements sometimes causes the vibration of the dope bead 230. However, when the casting die 81 is used, the vibration of the thin or wide dope bead 230 is reduced, and therefore the dope bead 230 is formed stably. Therefore, in the solution casting method and the solution casting apparatus in the present invention, the thin or wide film can be produced efficiently.

In the above embodiment, the faces 210b, 211b, 223b, 224b of the lip plates 210, 211 and the inner deckle plates 223, 224 are in parallel, and the explanation is made under this condition. However, in consideration of the actual processing of the faces, it is rear that the faces 210b, 211b, 223b, 224b of the lip plates 210, 211 and the inner deckle plates 223, 224 are in parallel. However, the present invention can be applied even if the faces 210b, 211b, 223b, 224b of the lip plates 210, 211 and the inner deckle plates 223, 224 are not in parallel. In this case, when a first ridge formed by the side face and the contact face of one of the members constructing the outlet 41a and a second ridge of another member are considered, the difference between the first and second ridges in the flow-out direction A1 is at most 9 μm. Thus the effect of the present invention is achieved. Therefore, when the inner deckle plate 223, 224 are protrudes from the side plates 210, 211 in the flow-out direction A1, otherwise when the side plates 210, 211 are protrudes from the inner deckle plate 223, 224 in the flow-out direction A1, the effect of the present invention is achieved under the condition that the protrusion length is at most 9 μm. Note that the condition of at most 9 μm is also satisfied if any protrusion cannot be found on the die lip. Therefore, also in this case, the effect of the present invention is achieved.

By the way, according to the side plates 210, 211 and the inner deckle plates 223, 224 in the lip end, any one of edges of the contact face sometimes curves in an in-plane direction of the contact face to form a jaggy (or zigzag) curve line. Therefore, in order to prevent the continuous occurrence of the partial recovering of the elastic shear distortion, it is preferable in the present invention to regulate a curve difference of each edge in a downstream end of the contact faces 210a, 211a, 223a, 224a, while the curve difference is defined as a maximum between a top and a bottom of the jaggy curve. It means that the present invention is more effectively performed if not only the protrusion length between the different ridges perpendicular to the flow-out direction but also the curve difference of each edge in the lower end portion of the member constructing the passage of the dope are regulated. Concretely, the curve difference is preferably at most 9 μm. For example, in this embodiment, the inner deckle plates 223, 224 are protrudes from the side plates 210, 211 in the flow-out direction on the downstream end of the slit 216, and the edges in the downstream end of the contact faces 210a, 211a, 223a, 224a are not only the ridges 210c, 211c, 223c, 224c which are perpendicular to the flow-out direction, but also ridges 223x 223y, 224x, 224y which are extending in the flow-out direction. The ridge 223x is an edge of the contact face 223a that connects the ridges 210c, 223c, the ridge 223y an edge of the contact face 223a that connects the ridges 211c, 223c, the ridge 224x an edge of the contact face 224a that connects the ridges 210c, 224c, and the ridge 224y an edge of the contact face 224a that connects the ridges 211c, 224c. The curve difference of each ridge 210c, 211c, 223c, 224c, 223x 223y, 224x, 224y is preferably at most 9 μm.

The regulation of the curve difference is made in the same manner even if the side plates 210, 211 protrudes from the inner deckle plates 223, 224 in the flow-out direction A1. In this case, the edges on the downstream end of the contact faces 210a, 211a, 223a, 224a are not only the ridges 210c, 211c, 223c, 224c, but also the face edges (not shown) of the downstream end of the contact faces 210a, 211a in the downstream side from the ridges 223c, 224c.

Furthermore, it is preferable in the present invention that the edges of the downstream end of the contact faces 210a, 211a, 223a, 224a may be curved to have an arc shape.

Since the dope to be used for the solution casting method is viscoelastic fluid, both side edges of the dope bead of the discharged casting die between the outlet and the support becomes thicker in effect of the neck-in phenomena. (hereinafter, the defect of called the edge defect). Even if the edge defect of the dope bead occurs in the film production, the both side edge portions of the produced film cannot be used as the film product, and therefore the production efficiency of the film becomes lower. Further, in the film production process, the casting film having the thick side edge portions causes the lower adhesiveness to the support. Thus the self supporting property of the casting film on the support cannot be enough, or the film twines around the rollers.

The neck-in phenomena causing the edge defect occurs more extremely, in the case that the viscosity of the dope becomes higher, and in the case that the air gap from the outlet to the support becomes larger. In order to make the viscosity of the dope, it is necessary to change the polymer composition or to use the dope of lower polymer concentration. Changing the polymer composition is not preferable because of the restriction to the optical properties of the film to be produced Further, using the dope of the lower polymer concentration causes the lower productivity, since the occurrence of the self supporting properties becomes harder.

Therefore, in order to prevent the defects caused by the neck-in phenomena of the casting dope 14, the air gap AG (see, FIG. 3) is preferably at most 100 mm, particularly at most 10 mm, and especially at most 5 mm. The air gap AG is the smallest distance between the surface of the support (the casting drum 82 and the like) and one of the ridges 210c, 211c, 223c, 224c. In order to prevent the defect of the casting drum 82 that is caused by the contacting of the casting drum 82 to the inner deckle plates 223, 224 formed of a hard material, the air gap AG is preferably at least 0.1 mm The air gap AG may be controlled depending on the position of the casting die 41, the largeness of the distances CL1-CL4, and the positional fluctuation in the up- and downward directions of the running casting drum 82.

Further, in order to make the air gap AG smaller, it is preferable to form the contact faces 210a, 211a, 223a, 224a such that the ridges 223c, 224c may be closer to the casting drum 82 than the ridges 210c, 211c. In order to prevent only the occurrence of the skinning, the contact faces 210a, 211a, 223a, 224a may be formed such that the ridges 210c, 211c may be closer to the casting drum 82 than the ridges 223c, 224c.

In order to make the air gap AG smaller, it is necessary to prevent the defeat of the casting drum 82 by contacting with the inner deckle plates 223, 224 at adjusting the air gap AG and casting the casting dope 14. In the conventional manner, the inner deckle plates are therefore produced from resins, such as Teflon (registered trademark) and the like. In the present invention, however, the inner deckle plates are formed of the hard material such as stainless, ceramics and the like, and thus the regulation of the distances CL1, CL4 and the regulation of the air gap AG can be made in high accuracy. Therefore, in the present invention, the defects caused by the neck-in phenomena are prevented while the skinning is prevented.

In order to prevent the defects caused by the die-swell phenomena and the neck-in phenomena, the viscosity of the casting dope 14 discharged from the outlet 41a of the casting die 41 is preferably in the range of 10 Pa·s to 200 Pa·s.

In the above embodiments, the distance W2 of the slit 216 is almost constant in the upstream side from the inclination face 227 of the inner deckle plates 223, 224, and the distance W2 of the die outlet 81a may become larger at a predetermined rate. However, the present invention is not restricted in this description. For example, the casting die may have the inner deckle plates, as shown in FIGS. 8 & 9.

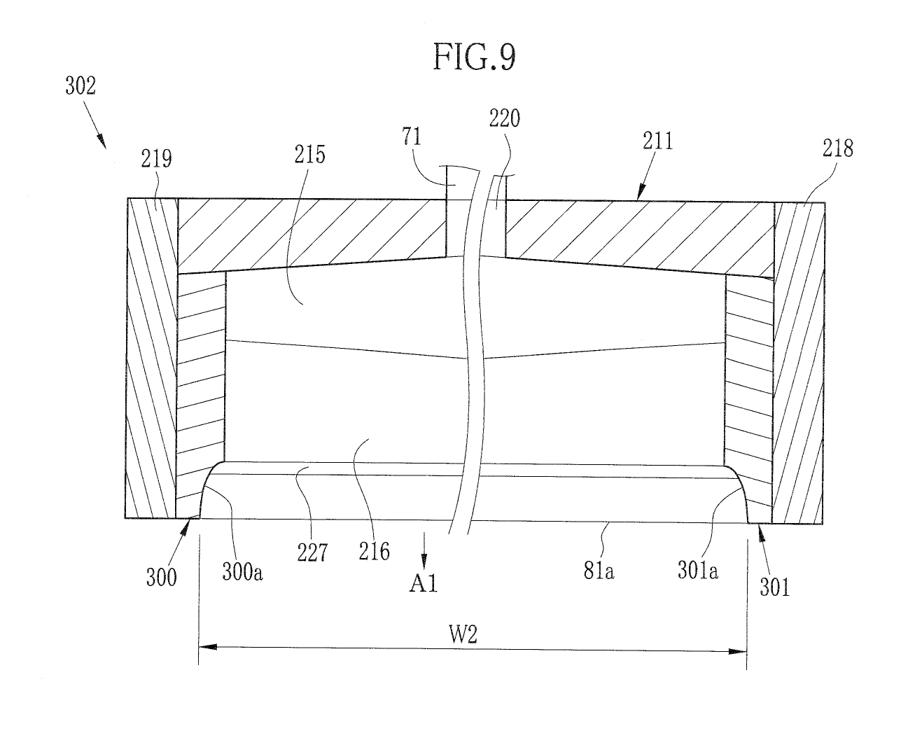

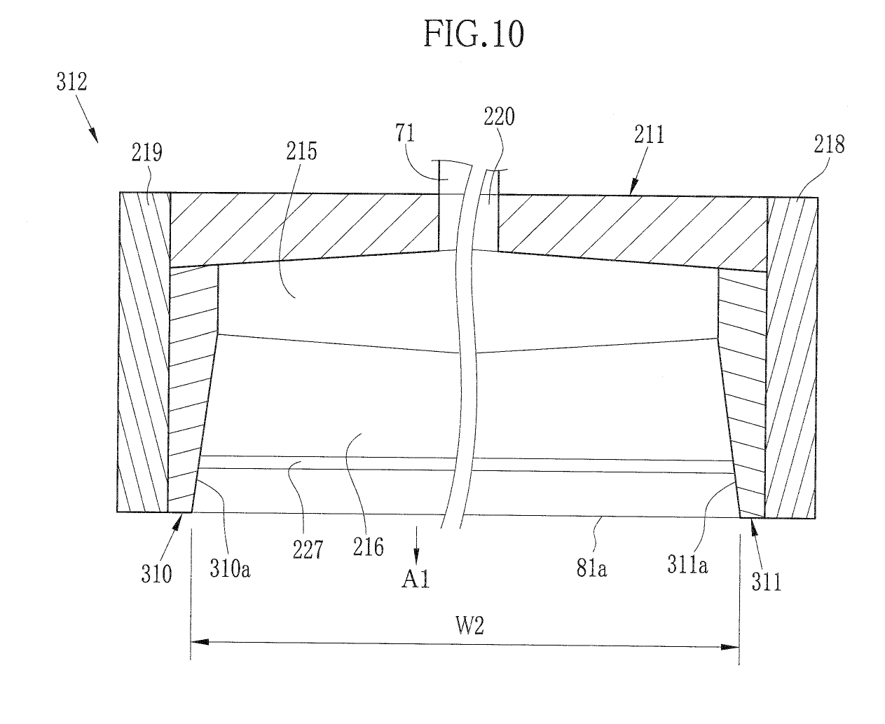

In FIG. 9, inner deckle plates 300, 301 have contact faces 300a, 301a. The distance W2 between the contact faces 300a and 301a is almost constant from the manifold 215 to the inclination 227 of the contact face 211a. The lower end portion of the contact faces 300a, 301a is a curving face curving to the outside of the widthwise direction of the casting die. Further, the extending rate of the distance W2 becomes smaller in a lower part of the slit near the outlet 81a. Further, as shown in FIG. 10, inner deckle plates 310, 311 have contact faces 310a, 311a in which inclination faces are respectively formed. Each inclination faces is longer in the discharging direction A1 in this FIG. 10 than that in FIG. 5. Thus the width of the slit becomes wider gradually.

In this embodiment, the inner deckle plates are plate members. However, the present invention is not restricted in it. Therefore, other types of inner deckle members may be used independent from the shape thereof, if the inner deckle members have contact faces for regulating the width of the casting dope to be discharged from the outlet.

In the present invention, the casting film 53 formed on the casting drum 82 is cooled so as to have the self supporting properties. However, the present invention is not restricted in it. For example, the present invention may be applied to a solution casting method, in which the drying is made such that the casting film 53 may have the self supporting property. Further, the casting drum 82 with a rotary shaft (not shown) is used as the support. However, instead thereof, an endless belt which runs running continuously may be used. Note that the belt is not restricted in it, and may be stationary disposed.

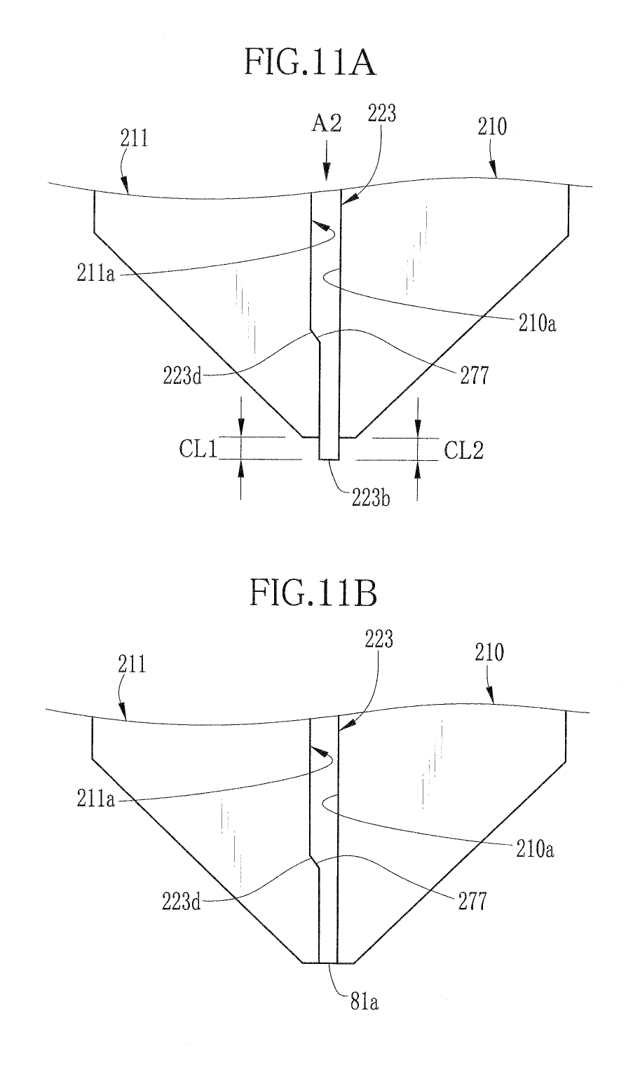

An example of an adjusting method of the distances CL1-CL4 will be described now in reference with FIGS. 11A & 11B. Note that the adjusting method is not restricted in the following description. At first, the lip plates 210, 211 and the inner deckle plates 223, 224 are obtained to have the predetermined sizes. Secondary, as shown in FIG. 11A, the lip plates 210, 211 and the inner deckle plates 223, 224 are combined. Thirdly, the distances CL1-CL4 are measured just after the combination of the lip plates 210, 211 and the inner deckle plates 223, 224. At the measurement, a force is applied in a direction A2 to the inner deckle plate 223, such that a face 223d of the inner deckle plate 223 and a face 221d of the lip plate 221 may contact to each other. According to the inner deckle plate 224 which is not shown in FIG. 11A, the measurement of the distances CL1-CL4 is made in the same manner. Fourthly, the inner deckle plates 223, 224 are removed, and the processing of the faces 223b, 224b is made such that the distances CL1-CL4 may be at most 9 μm. Thus distances CL1-CL4 are adjusted so as to have the predetermined value, as shown in FIG. 11B. Note that the direction A2 may be the discharging direction A1.

If the above adjusting method is made, it is preferable to further satisfy not only the above conditions (1)-(3) but also the following conditions:

(4) the rate of the volume fluctuation of the lip plates 210, 211 and the inner deckle plates 223, 224 just after the processing is at most 0.05%, and

(5) the inner deckle plates 223, 224 is not so hard as to damage the lip plates 210, 211.

It is preferable in the present invention, the rate of volume fluctuation of the lip plates 210, 211 and the inner deckle plates 223, 224 satisfies the above condition (4). The rate of volume fluctuation means a maximum of the rates of the size fluctuation aₓ, a_{y}, a_{z}, in the x, y, z Cartesian coordinate system. The rate of the size fluctuation ax is defined to Δbₓ/bₓ, in the case that the size fluctuation of the inner deckle plate 223, 224 is Δbₓ on the application of the outer force F (about 90 N) per unit size (1 mm²) in the x-axis direction and the size of the inner deckle plate before the application of the outer force is bₓ. The rate of the size fluctuation ay is defined to Δb_{y}/b_{y}, if the size fluctuation of the inner deckle plate 223, 224 is Δb_{y} on the application of the outer force F in the y-axis direction and the size of the inner deckle plate before the application of the outer force is by. The rate of the size fluctuation a_{z} is defined to Δb_{z}/b_{z}, in the case that the size fluctuation of the inner deckle plate 223, 224 is Δb_{z} on the application of the outer force F in the z-axis direction and the size of the inner deckle plate before the application of the outer force is b_{z}.

According to the condition (5), for example, if the precipitation hardened stainless is used as the material for the lip plates 210, 211, it is preferable that the materials for the inner deckle plate 223, 224 has the Vickers hardness in the range of 200 Hv to 1000 Hv. Therefore, the stainless or the ceramics are preferably used as the materials for the inner deckle plate 223, 224. Further, the material for the inner deckle plate preferably has magnetism. In this case, when the processing of the face 223b, 224b is made, the inner deckle plate 224, 224 is fixed by the magnet, and therefore the processing accuracy of the distances CL1-CL4 become higher.

The present invention may be applied to a solution casting method in which a casting belt supported by two rollers is used instead of the casting drum. In this case, the decompression chamber preferably decompresses in the upstream area from the casting bead in the running direction such that the pressure in the upstream area may be in the range of 100 Pa to 1000 Pa lower than the downstream area from the casting bead. Particularly preferably, the decompression may be made such that the pressure in the upstream area may be in the range of 150 Pa to 200 Pa lower than the downstream area.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the production of the film having multi-layer structure, the plural dopes are cast onto a support to form a casting film having a first layer (uppermost layer) and a second layer (lowermost layer). Then in the produced film, at least one of the thickness of the first layer and that of the lowermost layer opposite thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have lower viscosity than the dope for forming a layer sandwiched by the surface layers. Further, when the co-casting is designated, it is preferable in the dope bead between a die slit (or die lip) and the support that the composition of alcohol is higher in the two outer dopes than the inner dope.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/m² to 1000 mg/m². The functional layers preferably contain at least one sort of matting agents in the range of 0.1 mg/m² to 1000 mg/m². The functional layers preferably contain at least one sort of antistatic agents in the range of 1 mg/m² to 1000 mg/m².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in this publication No. 2005-104148 describes a cellulose acylate film provided with an optical anisotropic layer and that having antireflection and antiglare functions. Further, the produced film can be used as an optical compensation film since being double axial cellulose acylate film provided with adequate optical properties. Further, the optical compensation film can be used as a protective film for a polarizing filter. The detail description thereof is made from [1088] to [1265] in the publication No. 2005-104148.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

Further, the present invention is not restricted to the production of the optical film, and applied to the production of any film by the solution casting method. For example, the present invention is applied to the production of a solid electrolyte film as a proton transmitting material to be used for a fuel cell. Note that the polymer to be used in the present invention is not restricted in the cellulose acylate, but may be any polymer already known.

The experiments of the present invention were made, whose explanation will be made in followings.

### EXAMPLE 1

In Example 1, Experiments 1-11 were performed. The explanation of Example 1 will be made in detail, and the explanations of the same things in Experiments 2-11 will be omitted.

[Experiment 1]

The explanation of Example 1 is made now. The compositions for the preparation of the dope to be used for the film production were as follows:

<Solid Compounds>

| | |
|---|---|
| Cellulose Triacetate | 89.3 wt. % |
| (Degree of substitution, 2.8) | |
| Plasticizer A (triphenyl phosphate) | 7.1 wt. % |
| Plasticizer B (biphenyldiphenyl phosphate) | 3.6 wt. % |

<Solvent>

| | |
|---|---|
| Dichloromethane (first component of solvent) | 87 wt. % |
| Methanol (second component of solvent) | 12 wt. % |
| Betanol (third component of solvent) | 1 wt. % |

The solvent for the dope contained the first and second components of solvent, as described above. The solid compounds were added to the solvent adequately, such that the primary dope 48 was obtained. Note that the solid content in the obtained dope 11 were 19.3 wt. %. Then the primary dope 48 was filtrated with use of a filter (#63LB, produced by Toyo Roshi Kaisha, Ltd.), and further filtrated with use of a sintered metallic filter (06N, porous diameter 10 μm, produced by Nippon Seisen, Co., Ltd.). Furthermore, the primary dope 48 was filtrated with use of a mesh filter, and then stored in the stock tank 30.

<Cellulosetriacetate>

According to cellulose triacetate used in this experiment, the remaining content of acetic acid was at most 0.1 wt. %, the Ca content was 5 ppm, the Mg content was 70 ppm, the Fe content was 0.5 ppm, the free acetic acid was 40 ppm, and the sulfuric ion content was 15 ppm. The degree of acetylation at 6^{th} position was 0.91, and the percentage of acetyl groups at 6 ^{th} position to the total acetyl groups was 32.5%. The acetone extract was 8 wt. %, and a ratio of weight-average molecular weight to number-average molecular weight was 2.5. Further, yellow index was 1.7, haze was 0.08, and transparency was 93.5%. This cellulose triacetate is synthesized from cellulose as material obtained from cotton, and called cotton TAC in the following explanation.

<Preparation for Liquid of Matting Agent>

The matting agent liquid was prepared so as to contain the following compound, while the TAC was the same as that for the preparation of the primary dope 48:

| | |
|---|---|
| Silica | 0.67 wt. % |
| (Aerosil R972, produced by | |
| Nippon Aerosil Co., Ltd.) | |
| Cellulose triacetate | 2.93 wt. % |
| Triphenyl phosphate | 0.23 wt. % |
| Biphenyldiphenyl phosphate | 0.12 wt. % |
| Dichloromethane | 88.37 wt. % |
| Methanol | 7.68 wt. % |

The dispersion of the mixture of the above compounds was made with use of the attritor such that the average particle diameter in volume might be 0.7 μm. Thus the liquid of matting agent was prepared and then filtered with use of Astropore filter (produced by Fuji Photo Film Co., LTD.), and then stored in the matting agent tank.

<Preparation for Liquid of UV Absorbing Agent>

| | |
|---|---|
| UV-agent A | 5.83 wt. % |
| (2(2′-hydroxy-3′,5′-di-tert-butylphenyl)-5- | |
| chlorobenzotriazol) | |
| UV-agent B | 11.66 wt. % |
| (2(2′-hydroxy-3′,5′-di-tert- | |
| amylphenyl)benzotriazol) | |
| Cellulose triacetate | 1.48 wt. % |
| Triphenyl phosphate | 0.12 wt. % |
| Biphenyldiphenyl phosphate | 0.06 wt. % |
| Dichloromethane | 74.38 wt. % |
| Methanol | 6.47 wt. % |

The prepared liquid of UV absorbing agent was filtered with use of Astropore filter (produced by Fuji Photo Film Co., LTD.), and then stored in the UV agent tank.

The film 22 was produced with use of the film production line 32. The gear pump 73 increases the pressure in the primary side, and the primary dope 48 was fed with a feed back control to the upstream side from the pump with use of an inverter motor, such that the pressure in the primary side may be 0.8 MPa. As for the efficiencies of the gear pump 73, the volume efficiency was at most 99.2%, fluctuation percentage of the discharge volume was at most 0.5%. Further, the pressure for discharging was 1.5 MPa. The casting controller 79 drove and controlled the gear pump 73 to feed the primary dope 48 to the static mixer 75. In the filtration device 74, the filtration of the primary dope 48 was made.

In the additive supplying section 78, the matting agent liquid was added to the UV absorbing agent liquid, and the mixture is stirred such that a mixture additive was obtained. Then the mixture additive was fed through the additive supplying section 78 into the pipe 71. Thereafter the mixture of the mixture additive and the primary dope 48 was stirred by the static mixer 75.

The casting die 81 included the lip plates 210, 211, the side plates 212, 213, the inner deckle plates 223, 224, while these members of the casting die 81 was formed of stainless whose percentage of the volume fluctuation was 0.002%. As for the finish accuracy of the contact faces 210a, 211a, 223a, 224a of the lip plates 210, 211 and the inner deckle plates 223, 224, the surface roughness was at most 1 μm and the straightness was at most 1 μm in any directions. Further, as for the protruding in the edges of the outlet 41a, the distances CL1-CL4 were at most 2 μm. During the casting, the flow volume of the casting dope 51 was controlled such that the width of the casting film 53 might be 1.8 m and the thickness of the dried film 57 might be 60 μm. The temperature of a heat transfer medium was controlled to 36° C. at the entrance of the jacket, such that the temperature of the casting dope 51 may be controlled to 36° C.

In this experiment, the sizes of the lip plates 210, 211 and the inner deckle plates 223, 224 and the change of the sizes were measured with use of a microscope whose resolution was 1 μm.

The temperatures of casting die 81 and the pipe were controlled to 36° C. during the film production. The casting die 81 was the coat hunger type, in which heat bolts for adjusting the film thickness were disposed at the pitch of 20 mm. Thus the film thickness (or the thickness of the discharged casting dopes) is automatically controlled by the heat bolt. A profile of the heat volt can be set corresponding to the flow volume of a pump (not shown), on the basis of the preset program. Thus the feed back control can be made by the control program on the basis of the profile of an infrared ray thickness meter (not shown) disposed in the film production line 32. The control was made such that, with exception of both side edge portions (20 mm each in the widthwise direction of the produced film), the difference of the film thickness between two positions (50 mm apart from each other) might be at most 1 μm, and the largest difference between the minimal values of the film thickness in the widthwise direction might be at most 3 μm/m. Further, the average film thickness might was controlled in ±1.5%.

The primary side (namely the upstream side) of the casting die 81 is provided with the decompression chamber 90. The decompression rate of the decompression chamber 90 was controlled in accordance with the casting speed, such that the pressure difference might occur in the range of one Pa to 5000 Pa between the upstream and downstream sides of the dope bead of the discharged casting dope above the casting drum 82. At this time, the pressure difference between both sides of the dope bead was determined such that the length of the dope bead might be from 20 mm to 50 mm. Further, a jacket (not shown) was attached such that the inner temperature of the decompression chamber might be constant, and the inside of the jacket was supplied with a temperature transfer medium whose temperature was controlled to 35° C. Further, there was labyrinth packing (not shown) in the upstream and downstream sides of the dope beads.

The material of the lip plates 210, 211, the side plates 212, 213, and the inner deckle plates 223, 334 was the stainless steel, whose coefficient of -thermal expansion was at most 2×10⁻⁵ (° C.⁻¹) In the compulsory corrosion experiment in an electrolyte solution, the corrosion resistance was almost the same as that of SUS316. Further, the material to be used for the casting die 81 had enough corrosion resistance, such that the pitting (or pitting corrosion) might not occur on the gas--liquid interface even if this material were dipped in a mixture liquid of dichloromethane, methanol and water for three months. The finish accuracy of the contact surface of each casting die 81 to the casting dope 51 was at most 1 μm in surface roughness, and the slit clearance was adjusted to 1.5 mm in straightness. According to an edge of the contact portion of a lip end of the casting die 81, R is at most 50 μm in all of a width. Further, the shearing rate in the casting die 81 controlled in the range of one to 5000 per second. Further, the WC coating was made on the lip end from the casting die 81 by a melt extrusion method, so as to provide the hardened layer.

The casting drum 82 was a pillar shaped casting drum which was 3.0 m in width. The thickness of the casting drum 82 was 1.5 mm, and the surface of the casting drum 82 was polished, such that the surface roughness might be at most 0.05 μm. The material was SUS316, which had enough corrosion resistance and strength. The thickness unevenness of the entire casting drum 82 was at most 0.5% of the predetermined value. The casting drum 82 was moved by rotating the casting drum 82. The casting speed, namely the speed of the periphery 82b of the casting drum 82 in the rotary direction Z1, is in the range of 50 m/min to 200 m/min. The position of the belt in the widthwise direction was controlled with detection of the position of the side end, such that meandering in one circle of the casting drum 82 which is running was reduced in 1.5 mm. Further, below the casting die 81, the variation of the position in the vertical direction between the lip end of the casting die 81 and the casting drum 82 was in 200 μm.

In this experiment, the casting drum 82 was supplied therein with a heat transfer medium, such that the temperature T1 of the periphery 82b might be controlled. The casting drum 82 was supplied with the heat transfer medium (water) at a temperature in the range of 30° C. to 40° C. The surface temperature of the middle portion of the casting drum 82 at a position just before the casting was 0° C., and the temperature difference between both sides of the belt was at most 6° C. Note that a number of pinhole (diameter, at least 30 μm) was zero, a number of pinhole (diameter, at least 10 μm and less than 30 μm) was at most one in square meter, and a number of pinhole (diameter, less than 10 μm) was at most two in square meter.

Note that the oxygen concentration in the drying atmosphere on the casting drum 82 was kept to 5 vol % by substituting the air for nitrogen gas. In order to keep the oxygen concentration to 5 vol %, the inner air of the drying atmosphere was substituted by nitrogen gas. The solvent vapor in the casting chamber 62 was recovered by setting the temperature of exit of the condenser 87 to −3° C. The static fluctuation near the casting die 81 was reduced to at most +1 Pa.

While the casting dope 51 was cast from the casting die 81 onto the casting drum 82, the dope bead 230 was formed between the outlet 81a and the periphery 82b, and the solution 250 containing 50 wt. % of dichloromethane and 50 wt. % of methanol was supplied to the edge sides 230a of the dope bead 230 through the nozzles 252 at the predetermined flow volume in the range of 0.1 mL to 1 mL. Thus the discharged casting dope 51 formed the casting film 53 on the casting drum 82. The decompression chamber 90 decompressed the area of the rear face side of the dope bead 230. Further, when the decompression is made, the pressure in the rear face side is decreased to be lower than that in the front face side. The difference of the pressures in the areas from the front face side and the rear face side is described as a decompression value P1, and the decompression value P1 was about 850 Pa. When the casting film 53 has the self-supporting property, the casting film 53 was peeled as the wet film 55 from the casting drum 82 with support of the peel roller 83. In order to reduce the peeling defects, the percentage of the peeling speed (the draw of the peeling roller 83) to the speed of the casting drum 82 was controlled from 100.1% to 110%. The solvent vapor generated in the evaporation is condensed by the condenser 87 at −3° C. to a liquid state, and recovered by the recovering device 88. The water content of the recovered solvent was adjusted to at most 0.5%. Further, the air from which the solvent components were removed was heated again and reused for the drying air. The wet film 55 was transported with the path rollers 63 toward the pin tenter 64. Above the path rollers 63, the drying air at 60° C. was fed to the wet film 55 from the air blower.

In the pin tenter 64, both side edge portions of the wet film 55 were clipped or held by the clips, and the wet film 55 was transported through the temperature zones. During the transport in the pin tenter 64, the predetermined drying was made to the wet film 55, such that the content of the remaining solvent might be at most 5 wt. %. Thereafter the wet film 55 was fed out as the film 57 from the pint enter 64 to the edge slitting device 65.

The solvent vapor evaporated in the pin tenter 64 was condensed and liquidized at −3° C. by a condenser (not shown) for recovery of the solvent. Thereafter the water content of the recovered solvent was adjusted to at most 0.5 wt. %.

In 30 seconds from exit of the pin tenter 64, both side edge portions were slit off in the edge slitting device 65. In this experiment, each side portion of 50 mm in the widthwise direction of the film 57 was determined as the side edge portion, which were slit off by an NT type cutter of the edge slitting device 65. The slit side edge portions were sent to the crusher 95 by applying air blow from a blower (not shown), and crushed to tips about 80 mm². The tips were reused as raw material with the TAC frame for the dope production. The oxygen concentration in the drying atmosphere in the pin tenter 64 was kept to 5 vol. %. Note that the air was substituted by nitrogen gas in order to keep the oxygen concentration at 5 vol. %. Before the drying at the high temperature in the drying chamber 66, the pre-heating of the film 57 was made in a pre-heating chamber (not shown in which the air blow at 100° C. was supplied.

The film 57 was dried at high temperature in the drying chamber 66, which was partitioned into four partitions. Air blows whose temperatures were 120° C., 130° C., 130° C. and 130° C. from the upstream side were fed from air blowers (not shown) to the partitions. The transporting tension of each roller 91 to the film 57 was 100 N/m. The drying was made for ten minutes such that the content of the remaining solvent might be 0.3 wt. %. The lapping angle of the roller 100 was 80° and 190°. The rollers 100 were made of aluminum or carbon steel. On the surface, the hard chrome coating was made. The surfaces of the rollers 100 were smooth or processed by blast of matting process. The swing of the roller in the rotation was in 50 μm. Further, the bending of the roller 91 at the tension of 100 N/m was reduced to at most 0.5 mm.

The solvent vapor contained in the drying air is removed with use of the adsorbing device 101 in which an adsorbing agent was used. The adsorbing agent was active carbon, and the desorption was performed with use of dried nitrogen. The recovered solvent was reuse as the solvent for the dope preparation after the water content might be at most 0.3 wt. %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 wt. %, and almost of the remaining solvent vapor was recovered by the adsorption recovering.

The film 57 was transported to a first moisture controlling chamber (not shown). In the interval section between the drying chamber 66 and the first moisture controlling chamber, the drying air at 110° C. was fed. In the first moisture controlling chamber, the air whose temperature was 50° C. and dewing point was 20° C. was fed. Further, the film 57 was fed into a second moisture chamber (not shown) in which the curling of the film 57 was reduced. An air whose temperature was 90° C. and humidity was 70% was applied to the film 57 in the second moisture controlling chamber.

After the moisture adjustment, the film 57 was cooled to at most 30° C. in the cooling chamber 67, and then the edge slitting was performed. The compulsory neutralization device (or a neutralization bar) 104 was provided, such that in the transportation, the charged electrostatic potential of the film might be in the range of −3 kV to +3 kV. Further, the film knurling was made on a surface of each side of the film 57 by the knurling roller 105. The width of the knurling was 10 mm, and the knurling pressure was set such that the height from bottom to top of the film surface might be at most 12 μm larger in average than the averaged thickness.

The film 57 was transported to the winding chamber 68, whose inside temperature and humidity were respectively kept to 28° C. and 70%. Further, a compulsory neutralization device (not shown) was provided, such that the charged electrostatic potential of the film might be in the range of −1.5 kV to +1.5 kV. In the winding chamber 68, the obtained film 57 is wound up around the winding shaft 107 with applying the tension of the predetermined value.

[Experiment 2]

The decompression was made such that the area in the rear face side might be 350 Pa lower than the front face side, and other conditions were the same as in Example 1.

[Experiment 3]

The decompression was made such that the area in the rear face side might be 150 Pa lower than the front face side, and other conditions were the same as in Example 1.

[Experiment 4]

In the casting die 81, the distances CL1-CL4 were adjusted to at least 10 μm. The decompression was made such that the area in the rear face side might be 90 Pa lower than the front face side. Other conditions were the same as in Example 1.

[Experiment 5]

In the casting die 81, the distances CL1-CL4 were adjusted to at least 10 μm. The decompression was made such that the area in the rear face side might be 150 Pa lower than the front face side. Other conditions were the same as in Example 1.

[Experiments 6-11]

The changes of the conditions in Experiments 6-11 are shown in Table 1, and other conditions were the same as in Experiment 1. Note in Experiment 7, the decompression in the upstream area from the rear face 230c with the decompression chamber was not made, and other conditions were the same as Experiment 1, in the film production.

[Film Estimation]

In the examples of the above experiment, the estimation of the film was made in the points of the occurrence of the entrained air in the same manner among Experiments 1-11, the defects such as thickness unevenness that is caused by the unstableness of the dope bead. The estimation was made with the decompression value P1 of the decompression chamber 90 and the distances CL1-CL4 The result of the film estimation is shown in Table 1.

1. About the Occurrence of the Entrained Air (EA):

It was observed with eyes whether the entrained air entered in a space between the casting film and the casting drum. The estimations were as follows;

A. the entrained air was not recognized;

B. the slight entrained air was observed;

C. the entrained air was clearly observed.

2. About the vibration of the dope bead (BV):

It was observed with eyes whether the vibration of the dope bead 230 formed between the outlet and the periphery the solution 250 occurred. The estimations were as follows;

A. the vibration was not recognized;

B. the slight vibration was observed;

C. the vibration was clearly observed.

3. About the thickness unevenness (TU):

The film thickness of the obtained film was measured at five points on the film at 25° C. and 60 RH %, with use of an electronic micrometer (produced by Anritsu Corporation). Then the relative standard deviation RSD was calculated from the average and the deviation of values obtained by the measurement, as follows:

RSD=(Deviation/Average)×100

On the base of the value of RSD, the estimation of the thickness unevenness was made as follows;

A. thickness unevenness was less than 5%, and the thickness uniformity is excellent;

B. thickness unevenness was at least 5% and less than 10%, and the slight thickness unevenness occurred, which are not problematic for using the produced film as the optical film;

C. thickness unevenness was 10% or more, and the thickness unevenness are too much.

TABLE 1

Conditions

| | P1 | CL1-CL4 | Estimations | | |
|---|---|---|---|---|---|
| | (Pa) | (μm) | 1 | 2 | 3 |
| Ex. 1 | 850 | 2 | A | A | A |
| Ex. 2 | 350 | 2 | A | A | A |
| Ex. 3 | 150 | 2 | A | A | A |
| Ex. 4 | 90 | At least 10 | C | C | C |
| Ex. 5 | 150 | At least 10 | A | C | C |
| Ex. 6 | 850 | 9 | A | A | A |
| Ex. 7 | — | 2 | C | C | C |
| Ex. 8 | 1000 | 2 | A | A | A |
| Ex. 9 | 100 | 2 | A | A | A |
| Ex. 10 | 50 | 2 | B | B | B |
| Ex. 11 | 1100 | 2 | A | B | B |

As known from Table 1 clearly, in Examples 1-3 to which the present invention was applied, the entering of the entrained air between the periphery 82b and the casting film 53 and the dope bead vibration that causes the thickness unevenness are reduced. Further, even if the film production was performed continuously for at least 1000 hours, the skinning didn't occur, and thus the productivity became larger.

### EXAMPLE 2

[Experiment 1]

The used cellulose acetate were obtained by synthesizing the cellulose as the row material that was obtained from the woods. The Ca content in the cellulose acetate was 5 ppm, and 2-(3-t-butyl-5-methyl-2-hydroxyphenyl)-5-chlorobenzotriazol was used as the UV agent A. Other conditions were the same as Example 1.

[Experiments 2-11]

2-(3-t-butyl-5-methyl-2-hydroxyphenyl)-5-chlorobenzot riazol was used as the UV agent A. Other conditions of Examples 7-10 were the same as Experiments 2-11, respectively.

Also in Example 2, the estimations of the produced film were made about the entrained air, the vibration of the casting bead, and the thickness unevenness, in the same manner as Example 1. The results of Experiments 1-11 of Example 2 were the same as those in Example 1.

The solution casting method and the solution casting apparatus of the present invention can reduce the vibration of the dope bead under the conditions of the high speed casting and the low pressure, and therefore the thin or wide film can be produced effectively.

Various changes and modifications are possible in the present invention and may be understood to be within the present invention.

What is claimed is:

1. A solution casting method comprising steps of: providing a casting device for flowing out from a slit a dope containing a polymer, said casting device including a pair of first slit members forming first walls of said slit and a pair of second slit members forming second walls of said slit, said first walls extending in a lengthwise direction of said slit, said second walls extending in a widthwise direction of said slit, a protrusion length of a protrusion being at most 9 μm upon providing for said second slit member with said protrusion protruding from said first slit member in a flow-out direction of said dope or for said first slit member with said protrusion protruding from said second slit member in said flow-out direction;
continuously running a support;
flowing out from an outlet of said slit said dope so as to form a casting film on said support, said dope forming a dope bead between said outlet and said support;
decompressing in an upstream area from said dope bead in a running direction;
peeling said casting film from said support; and
drying said peeled casting film to a film.

2. A solution casting method described in claim 1, wherein the decompression is made such that a pressure in said upstream area from said dope bead may be in the range of 100 Pa to 1000 Pa lower than that of a downstream area from said dope bead in said running direction.

3. A solution casting method described in claim 1, wherein a film thickness of said film is in the range of 20 μm to 70 μm.

4. A solution casting method described in claim 1, wherein a width of said film is at least 1.5 m and at most 3 m.

5. A solution casting method described in claim 1, wherein a running speed of said support is in the range of 50 m/min to 200 m/min.

6. A solution casting method described in claim 1, wherein said support is a casting drum or a casting belt.

7. A solution casting apparatus, comprising:
a casting device for flowing out onto said support a dope containing a polymer and a solvent so as to form a casting film, said casting device including a pair of first slit members forming first walls of said slit and a pair of second slit members forming second walls of said slit, said first walls extending in a lengthwise direction of said slit, said second walls extending in a widthwise direction of said slit, a protrusion length of a protrusion being at most 9 μm upon providing for said second slit member with said protrusion protruding from said first slit member in a flow-out direction of said dope or for said first slit member with said protrusion protruding from said second slit member in said flow-out direction;
a continuously running support for receiving a dope bead formed by said dope flowing out from said slit;
a decompression chamber for decompressing in an upstream area from said dope bead in a running direction; and
a drying device for drying said casting film peeled from said support such that a film may be obtained.

8. A solution casting apparatus described in claim 7, wherein the decompression is made such that a pressure in said upstream area from said dope bead may be in the range of 100 Pa to 1000 Pa lower than that of a downstream area from said dope bead in said running direction.

9. A solution casting apparatus described in claim 7, wherein a film thickness of said film is in the range of 20 μm to 70 μm.

10. A solution casting apparatus described in claim 7, wherein a width of said film is at least 1.5 m and at most 3 m.

11. A solution casting apparatus described in claim 7, wherein a running speed of said support is in the range of 50 m/min to 200 m/min.

12. A solution casting apparatus described in claim 7, wherein said support is a casting drum or a casting belt.
